(19) United States
(12) Patent Application Publication
(10) Pub. No.: US 2014/0189153 A1
(43) Pub. Date: Jul. 3, 2014

(54) Methods, Systems, and Computer Program Products for Routing Based on a Scope-Specific Address

(71) Applicant: DEEP RIVER VENTURES, LLC, Raleigh, NC (US)

(72) Inventor: Robert Paul Morris, Raleigh, NC (US)

(73) Assignee: DEEP RIVER VENTURES, LLC, Raleigh, NC (US)

(21) Appl. No.: 13/727,652

(22) Filed: Dec. 27, 2012

(51) Int. Cl. H04L 29/08

(52) U.S. Cl. CPC H04L 67/02
USPC 709/238

(57) ABSTRACT

Methods and systems are described for routing based on a scope-specific address space. In an aspect, data is received data, from a previous node by a current node via a previous network interface operatively coupling the current node to a network, in a data unit that is specified according to a network protocol and that includes address information. A detection is made, based on the address information, a current-next protocol address that, in a current scope-specific address space specific to a current region including the current node, identifies a next node that is not included in the current region. A determination is made, based on the current-next protocol address, a next network interface operatively coupling the current node to the network. The data is sent, via the next network interface, to the next node.

### RELATED APPLICATIONS

This application is related to the following commonly owned, pending U.S. patent applications, by the present inventor, the entire disclosures being incorporated by reference herein:

Application Ser. No. 13/727,647 (Docket No DRV0025) filed on 2012 Dec. 27, entitled “Methods, Systems, and Computer Program Products for Identifying a Protocol Address Based on Path Information”;

Application Ser. No. 13/727,649 (Docket No DRV0026) filed on 2012 Dec. 27, entitled “Methods, Systems, and Computer Program Products for Assigning an Interface Identifier to a Network Interface”;

Application Ser. No. 13/727,651 (Docket No DRV0027) filed on 2012 Dec. 27, entitled “Methods, Systems, and Computer Program Products for Routing Based on a Nested Protocol Address”;

Application Ser. No. 13/727,653 (Docket No DRV0029) filed on 2012 Dec. 27, entitled “Methods, Systems, and Computer Program Products for Identifying a Protocol address in a Scope-specific Address Space”;

Application Ser. No. 13/727,655 (Docket No DRV0030) filed on 2012 Dec. 27, entitled “Methods, Systems, and Computer Program Products for Determining a Shared identifier for a Hop in a Network”;

Application Ser. No. 13/727,657 (Docket No DRV0031) filed on 2012 Dec. 27, entitled “Methods, Systems, and Computer Program Products for Determining a Hop Identifier for a Network Protocol”; and

Application Ser. No. 13/727,662 (Docket No DRV0032) filed on 2012 Dec. 27, entitled “Methods, Systems, and Computer Program Products for Routing Based on a Path-Based Protocol Address”.

### BACKGROUND

It is unlikely that the designers of the early network that is now referred to as the “Internet” expected it to become as large as it has become. The fact that the global Internet Protocol (IP) address space for 32-bit addresses has been fully allocated is evidence of this. As the Internet grows, new problems will arise and some current problems are getting worse. For example, while network speeds and bandwidth are increasing, so are causes of network latency.

The Internet Engineering Task Force (IETF) has taken steps at various times in the past and are presently taking steps to address a number of problems resulting from the Internet's growth. Problems addressed by the IETF are described in a number of “Request for Comments” (RFC) documents published the IETF. Documents referenced herein and included by reference include: “Request for Comments” (RFC) document RFC 791 edited by J. Postel, titled “Internet Protocol, DARPA Internet Protocol Specification”, published by the IETF in September, 1981;

“Request for Comments” (RFC) document RFC 1519 by V. Fuller, et al, titled “Classless Inter-Domain Routing (CIDR): An Address Assignment and Aggregation Strategy”, published by the Internet Engineering Task Force (IEFT), in June, 1999;

“Request for Comments” (RFC) document RFC 2460 by S. Deering, et al, titled “Internet Protocol, Version 6, (IPv6) Specification”, published by the IETF in December, 1998;

“Request for Comments” (RFC) document RFC 3513 by R. Hinden, et al, titled “Internet Protocol Version 6 (IPv6) Addressing Architecture”, published by the IETF in April, 2003; and

“Request for Comments” (RFC) document RFC 2374 by R. Hinden, et al, titled “Aggregatable Global Unicast Address Format”, published by the IETF in July, 1998.

RFC 791 states, “The internet protocol implements two basic functions: addressing and fragmentation”. RFC 791 goes on to state, “A distinction is made between names, addresses, and routes. A name indicates what we seek. An address indicates where it is. A route indicates how to get there. The internet protocol deals primarily with addresses. It is the task of higher level (i.e., host-to-host or application) protocols to make the mapping from names to addresses. The internet module maps internet addresses to local net addresses. It is the task of lower level (i.e., local net or gateways) procedures to make the mapping from local net addresses to routes”.

As demonstrated in the RFCs listed above, addressing has been a source of a number of problems. In order to address a number of current and future problems facing the Internet, the subject matter described herein challenges the distinctions asserted in RFC 791 between and among names, addresses, and routes.

Accordingly, there exists a need for methods, systems, and computer program products for routing based on a scope-specific address space.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for routing based on a scope-specific address space. In one aspect, the method includes receiving data, via a network from a previous node by a current node via a previous network interface operatively coupling the current node to the network, in a data unit that is specified according to a network protocol and that includes address information. The method further includes detecting, based on the address information, a current-next protocol address that, in a current scope-specific address space specific to a current region including the current node, identifies a next node. The method still further includes determining, based on the current-next protocol address, a next network interface operatively coupling the current node to the network. The method also includes sending, via the next network interface, the data to the next node. Performing at least one element identified above as included in the method includes execution of an instruction by a processor.

Further, a system for routing based on a scope-specific address space is described. The system includes an in-data handler component operable for and/or otherwise included in receiving data, via a network from a previous node by a current node via a previous network interface operatively coupling the current node to the network, in a data unit that is specified according to a network protocol and that includes address information. The system further includes a routing component operable for and/or otherwise included in detecting, based on the address information, a current-next protocol address that, in a current scope-specific address space specific to a current region including the current node, identifies a next node. The system still further includes a forwarding component operable for and/or otherwise included in determining, based on the current-next protocol address, a next network interface operatively coupling the current node to the network. The system still further includes an out-data handler component operable for and/or otherwise included in sending, via the next network interface, the data to the next node. The system also includes a processor, wherein at least one of the in-data handler component, the routing component, the forwarding component, and the out-data handler component includes an instruction that is executed by the processor during operation of the system.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for routing based on a scope-specific address space according to an aspect of the subject matter described herein;

FIG. 3 is a block diagram illustrating an arrangement of components for routing based on a scope-specific address space according to another aspect of the subject matter described herein;

FIG. 4A is a block diagram illustrating an arrangement of components for routing based on a scope-specific address space according to another aspect of the subject matter described herein;

FIG. 4B is a block diagram illustrating an arrangement of components for routing based on a scope-specific address space according to another aspect of the subject matter described herein;

FIG. 4C is a block diagram illustrating an arrangement of components for routing based on a scope-specific address space according to another aspect of the subject matter described herein;

FIG. 5A is a network diagram illustrating an exemplary system for routing based on a scope-specific address space according to another aspect of the subject matter described herein;

FIG. 5B is a network diagram illustrating an exemplary system for routing based on a scope-specific address space according to another aspect of the subject matter described herein;

FIG. 5C is a network diagram illustrating an exemplary system for routing based on a scope-specific address space according to another aspect of the subject matter described herein;

FIG. 6A is a diagram illustrating an exemplary representation of a protocol address according to another aspect of the subject matter described herein;

FIG. 6B is a diagram illustrating an exemplary representation of a scope-specific protocol address according to another aspect of the subject matter described herein;

FIG. 6C is a diagram illustrating an exemplary representation of a scope-specific protocol address according to another aspect of the subject matter described herein;

FIG. 6D is a diagram illustrating an exemplary representation of a node-specific protocol address according to another aspect of the subject matter described herein; and

FIG. 6E is a diagram illustrating an exemplary representation of a node-specific protocol address according to another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure. It is to be understood that other embodiments and/or aspects may be utilized and structural and functional modifications may be made without departing from the scope of the subject matter disclosed herein.

The use of “including”, “comprising”, “having”, and variations thereof are meant to encompass the items listed thereafter and equivalents thereof as well as additional items and equivalents thereof. Terms used to describe interoperation and/or coupling between components are intended to include both direct and indirect interoperation and/or coupling, unless otherwise indicated. Exemplary terms used in describing interoperation and/or coupling include “mounted,” “connected,” “attached,” “coupled,” “communicatively coupled,” “operatively coupled,” “invoked”, “called”, “provided to”, “received from”, “identified to”, “interoperated” and similar terms and their variants.

As used herein, any reference to an entity “in” an association is equivalent to describing the entity as “included in and/or identified by” the association, unless explicitly indicated otherwise.

Unless otherwise defined, all technical and scientific terms used herein have the same meaning as commonly understood by one of ordinary skill in the art to which this disclosure belongs. Although methods, components, and devices similar or equivalent to those described herein can be used in the practice or testing of the subject matter described herein, suitable methods, components, and devices are described below.

All publications, patent applications, patents, and other references mentioned herein are incorporated by reference in their entirety. In case of conflict, the present disclosure, including definitions, will control. In addition, the materials, methods, and examples are illustrative only and not intended to be limiting.

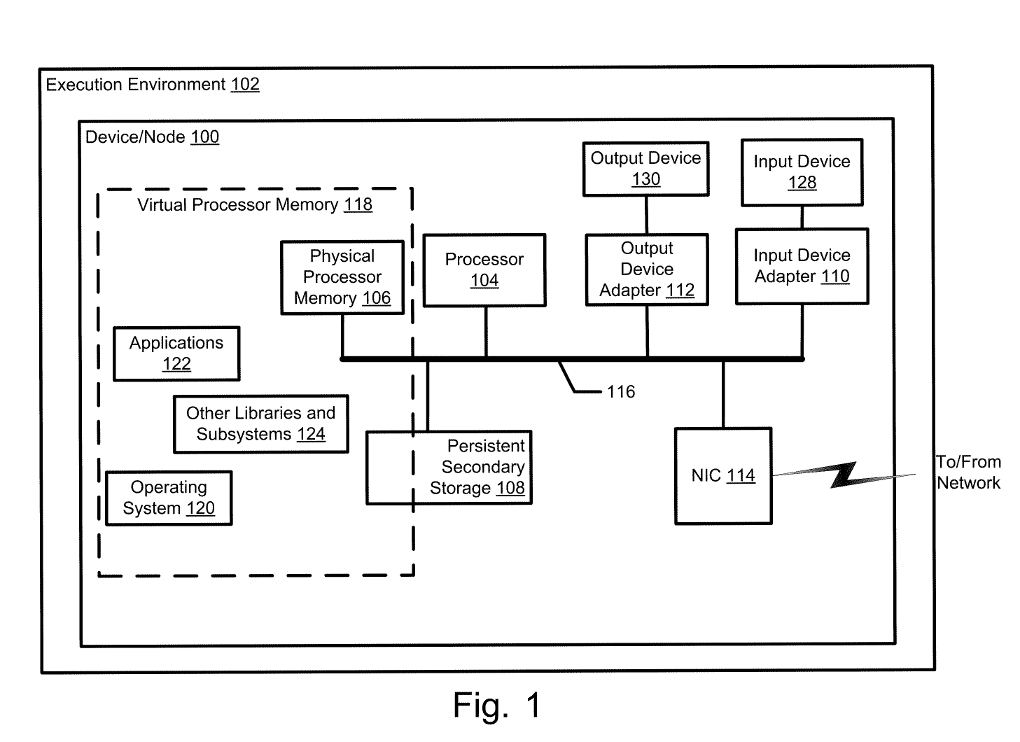

An exemplary device included in an execution environment that may be programmed, adapted, modified, and/or otherwise configured according to the subject matter is illustrated in FIG. 1. An “execution environment”, as used herein, is an arrangement of hardware and, in some aspects, software that may be further modified, transformed, and/or otherwise configured to include and/or otherwise host an arrangement of components to perform a method of the subject matter described herein. An execution environment includes and/or is otherwise provided by one or more devices. The execution environment is said to be the execution environment “of” the device and/or devices. An execution environment may be and/or may include a virtual execution environment including software components operating in a host execution environment. Exemplary devices included in and/or otherwise providing suitable execution environments that may be adapted, programmed, and/or otherwise modified according to the subject matter include a workstation, a desktop computer, a laptop or notebook computer, a server, a handheld computer, a mobile telephone or other portable telecommunication device, a media playing device, a gaming system, a tablet computer, a portable electronic device, a handheld electronic device, a multiprocessor device, a distributed system, a consumer electronic device, a router, a network server, or any other type and/or form of computing, telecommunications, network, and/or media device that is suitable to perform the subject matter described herein. Those skilled in the art will understand that the components illustrated in FIG. 1 are exemplary and may vary by particular execution environment.

FIG. 1 illustrates a hardware device 100 included in an execution environment 102. FIG. 1 illustrates that execution environment 102 includes a processor 104, such as one or more microprocessors; a physical processor memory 106 including storage locations identified by addresses in a physical memory address space of processor 104; a persistent secondary storage 108, such as one or more hard drives and/or flash storage media; an input device adapter 110, such as a key or keypad hardware, a keyboard adapter, and/or a mouse adapter; an output device adapter 112, such as a display and/or an audio adapter to present information to a user; a network interface component, illustrated by a network interface adapter 114, to communicate via a network such as a LAN and/or WAN; and a mechanism that operatively couples elements 104-114, illustrated as a bus 116. Elements 104-114 may be operatively coupled by various means. Bus 116 may comprise any type of bus architecture, including a memory bus, a peripheral bus, a local bus, and/or a switching fabric.

As used herein a “processor” is an instruction execution machine, apparatus, or device. A processor may include one or more electrical, optical, and/or mechanical components that operate in interpreting and executing program instructions. Exemplary processors include one or more microprocessors, digital signal processors (DSPs), graphics processing units, application-specific integrated circuits (ASICs), optical or photonic processors, and/or field programmable gate arrays (FPGAs). Processor 104 may access instructions and data via one or more memory address spaces in addition to the physical memory address space. A memory address space includes addresses identifying locations in a processor memory. The addresses in a memory address space are included in defining a processor memory. Processor 104 may have more than one processor memory. Thus, processor 104 may have more than one memory address space. Processor 104 may access a location in a processor memory by processing an address identifying the location. The processed address may be identified by an operand of an instruction and/or may be identified by a register and/or other portion of processor 104.

FIG. 1 illustrates a virtual processor memory 118 spanning at least part of physical processor memory 106 and may span at least part of persistent secondary storage 108. Virtual memory addresses in a memory address space may be mapped to physical memory addresses identifying locations in physical processor memory 106. An address space including addresses that identify locations in a virtual processor memory is referred to as a “virtual memory address space”; its addresses are referred to as “virtual memory addresses”; and its processor memory is referred to as a “virtual processor memory” or “virtual memory”. The term “processor memory” may refer to physical processor memory, such as processor memory 106, and/or may refer to virtual processor memory, such as virtual processor memory 118, depending on the context in which the term is used.

Physical processor memory 106 may include various types of memory technologies. Exemplary memory technologies include static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Ferroelectric RAM (FRAM), RAMBUS DRAM (RDRAM) Direct DRAM (DRDRAM), and/or XDR™ DRAM. Physical processor memory 106 may include volatile memory as illustrated in the previous sentence and/or may include non-volatile memory such as non-volatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable data storage medium. The drives and their associated computer readable media provide volatile and/or nonvolatile storage for computer-executable instructions, data structures, program components, and other data.

Execution environment 102 may include software components stored in persistent secondary storage 108, in remote storage accessible via a network, and/or in a processor memory. FIG. 1 illustrates execution environment 102 including an operating system 120, one or more applications 122, and other program code and/or data components illustrated by other libraries and subsystems 124. In an aspect, some or all software components may be stored in locations accessible to processor 104 in a shared memory address space shared by the software components. The software components accessed via the shared memory address space may be stored in a shared processor memory defined by the shared memory address space. In another aspect, a first software component may be stored in one or more locations accessed by processor 104 in a first address space and a second software component may be stored in one or more locations accessed by processor 104 in a second address space. The first software component is stored in a first processor memory defined by the first address space and the second software component is stored in a second processor memory defined by the second address space.

Software components typically include instructions executed by processor 104 in a computing context referred to as a “process”. A process may include one or more “threads”. A “thread” includes a sequence of instructions executed by processor 104 in a computing sub-context of a process. The terms “thread” and “process” may be used interchangeably herein when a process includes only one thread.

Execution environment 102 may receive user-provided information via one or more input devices illustrated by an input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding network interfaces such as a serial port, a parallel port, and/or a universal serial bus (USB) port. Input device adapter 110 may receive input and provide a representation to bus 116 to be received by processor 104, physical processor memory 106, and/or other components included in execution environment 102.

An output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred herein to as “sensory input” with respect to the user.

A device included in and/or otherwise providing an execution environment may operate in a networked environment communicating with one or more devices via one or more network interface components. FIG. 1 illustrates network interface adapter (NIA) 114 as a network interface component included in execution environment 102 to operatively couple device 100 to a network. A network interface component includes a network interface hardware (NIH) component and optionally a network interface software (NIS) component. Exemplary network interface components include network interface controllers, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., AMPS, TDMA, CDMA, GSM, GPRS UMTS, and/or PCS network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component to operatively couple the device to a network. Further, the terms “device” and “node” used herein refer to one or more devices and nodes, respectively, providing and/or otherwise included in an execution environment unless clearly indicated otherwise.

The user-detectable outputs of a user interface are generically referred to herein as “user interface elements” or abbreviated as “UI elements”. More specifically, visual outputs of a user interface are referred to herein as “visual interface elements”. A visual interface element may be a visual output of a graphical user interface (GUI). Exemplary visual interface elements include icons, image data, graphical drawings, font characters, windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes, and radio buttons. An application interface may include one or more of the elements listed. Those skilled in the art will understand that this list is not exhaustive. The terms “visual representation”, “visual output”, and “visual interface element” are used interchangeably in this document. Other types of UI elements include audio outputs referred to as “audio interface elements”, tactile outputs referred to as “tactile interface elements”, and the like.

A “user interface (UI) element handler” component, as the term is used herein, refers to a component that operates to send information representing a program entity to present a user-detectable representation of the program entity by an output device, such as a display. A “program entity” is an object, such as a variable or file, included in and/or otherwise processed by an application or executable. The user-detectable representation is presented based on the sent information. Information that represents a program entity to present a user detectable representation of the program entity by an output device is referred to herein as “presentation information”. Presentation information may include and/or may otherwise identify data in one or more formats. Exemplary formats include image formats such as raw pixel data, JPEG, video formats such as MP4, markup language data such as hypertext markup language (HTML) and other XML-based markup, a bit map, and/or instructions such as those defined by various script languages, byte code, and/or machine code. For example, a web page received by a browser or more generally a user agent from a remote application provider may include HTML, ECMAScript, and/or byte code to present one or more UI elements included in a user interface of the remote application. Components that send information representing one or more program entities to present particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided to store and/or otherwise represent presentation information, which may include audio, visual, tactile, and/or other sensory data for presentation by and/or on an output device. For example, a memory buffer to store an image and/or text string may be a presentation space as sensory information for a user. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

An “interaction”, as the term is used herein, refers to any activity including a user and an object where the object is a source of sensory data detected by the user and/or the user is a source of input for the object. An interaction, as indicated, may include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input component of the portable electronic device exemplifies the device, as an input target, receiving input from the user. Note that the user in providing input is receiving sensory information from the portable electronic. An interaction may include an input from the user that is detected and/or otherwise sensed by the device. An interaction may include sensory information that is received by a user included in the interaction that is presented by an output device included in the interaction.

As used herein “interaction information” refers to any information that identifies an interaction and/or otherwise provides data about an interaction between a user and an object, such as a portable electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction.

Interaction information for one object may include and/or otherwise identify interaction information for another object. For example, a motion detector may detect a user's head turn in the direction of a display of a portable electronic device. Interaction information indicating that the user's head is facing the display may be received and/or used as interaction information for the portable electronic device indicating the user is receiving visual input from the display. The interaction information may serve to indicate a lack of user interaction with one or more other objects in directions from the user different than the detected direction, such as a person approaching the user from behind the user. Thus, the interaction information may serve as interaction information for one or more different objects.

As used herein, the terms “program” and “executable” refer to any data representation that may be and/or may be translated into a set of machine code instructions and may optionally include associated program data. The terms are used interchangeably herein. Program representations other than machine code include object code, byte code, and source code. Object code includes a set of instructions and/or data elements that either are prepared to link prior to loading or are loaded into an execution environment. When in an execution environment, object code may include references resolved by a linker and/or may include one or more unresolved references. The context in which this term is used will make clear the state of the object code when it is relevant. This definition can include machine code and virtual machine code, such as Java™ byte code. A program and/or executable may include one or more components, referred to herein as a “program component”, “software component”, and/or “executable component”. As used herein, the terms “application”, and “service” may be realized in one or more program components and/or in one or more hardware components.

As used herein, the term “network protocol” refers to a set of rules, conventions, and/or schemas that govern how nodes exchange information over a network. The set may define, for example, a convention and/or a data structure. The term “network path” as used herein refers to a sequence of nodes in a network that are communicatively coupled to transmit data in one or more data units of a network protocol between a pair of nodes in the network.

A “data unit”, as the term is used herein, is an entity specified according to a network protocol to transmit data between a pair of nodes in a network path to send the data from a source node to a destination node that includes an identified protocol endpoint of the network protocol. A network protocol explicitly and/or implicitly specifies and/or otherwise identifies a schema that defines one or more of a rule for a format for a valid data unit and a vocabulary for content of a valid data unit. One example of a data unit is an Internet Protocol (IP) packet. The Internet Protocol defines rules for formatting an IP packet that defines a header to identify a destination address that identifies a destination node and a payload portion to include a representation of data to be delivered to the identified destination node. Various address types are specified defining a vocabulary for one or more address portions of an IP data unit. The terms “data unit”, “frame”, “data packet”, and “packet” are used interchangeably herein. One or more data units of a first network protocol may transmit a “message” of a second network protocol. For example, one or more data units of the IP protocol may include a TCP message. In another example, one or more TCP data units may transmit an HTTP message. A message may be empty.

How data is packaged in one more data units for a network protocol may vary as the data traverses a network path from a source node to a destination node. Data may be transmitted in a single data unit between two consecutive nodes in a network path. Additionally, data may be exchanged between a pair of consecutive nodes in several data units each including a portion of the data. Data received in a single data unit by a node in a network path may be split into portions included in several respective data units to transmit to a next node in the network path. Portions of data received in several data units may be combined into a single data unit to transmit by a node in a network path. For purposes of describing the subject matter, a data unit in which data is received by a node is referred to as a different data unit than a data unit in which the data is forwarded by the node.

A “protocol address”, as the term is used herein, for a network protocol is an identifier of a protocol endpoint that may be represented in a data unit of the network protocol. For example, 192.168.1.1 is an IP protocol address represented in a human readable format that may be represented in an address portion of an IP header to identify a source and/or a destination IP protocol endpoint. A protocol address differs from a symbolic identifier, defined below, in that a symbolic identifier, with respect to a network protocol, maps to a protocol address. Thus, “www.mynode.com” may be a symbolic identifier for a node in a network when mapped to the protocol address 192.168.1.1. An identifier may be both a symbolic identifier and a protocol address depending on its role with respect to its use for a particular network protocol.

Since a protocol endpoint is included in a node and is accessible via a network via a network interface, a protocol address identifies a node and identifies a network interface of the node. A network interface may include one or more NICs operatively coupled to a network.

A node in a pair of nodes in a network path at one end of the sequence of nodes in the network path and/or the other end is referred to herein as a “path end node”. Note that a node may have two NICs with one NIC at each end of a network path. A network path may be included as a portion of another network path that communicatively couples a same pair of nodes. Data may be transmitted via the sequence of nodes in a network path between path end nodes communicatively coupled via the network path. Data may be transmitted in one or both directions depending on an ordering of the nodes in the sequence.

The term “hop” as used herein refers to a pair of consecutive nodes in a network path to transmit, via a network protocol, data sent from a source node to a destination node. A “hop path” is thus a sequence of hops in a network that respectively include a sequence of pairs of consecutive nodes included in transmitting data from a first path end node of the network path to a second path end node of the network path.

The term “path-based protocol address” as used herein refers to a protocol address for a network protocol that includes one or more path segment identifiers that identify one or more respective portions of a network path identified by the path-based protocol address. A “node-based protocol address” is a path-based protocol address that includes a plurality of node identifiers that identify a sequence of nodes in a network path. A “network-interface-based protocol address” is a path-based protocol address that includes a plurality of interface identifiers that identify a sequence of network interfaces in a network path. A “NIC-based protocol address” is a type of network-interface-based protocol address that includes a plurality of identifiers that identify a sequence of network interface components. A “hop-based protocol address” is a type path-based protocol address since a hop is a type of network path.

Given the above definitions, note that the terms “network path” and “hop” may be defined in terms of network interfaces. A “network path” and a “hop path” include a sequence of network interfaces in a network that are included in transmitting data between a pair of path end nodes in the network. A “hop” refers to at least part of a network path that includes a pair of consecutive network interfaces in a sequence of network interfaces in a network path. A “network path” is thus a sequence of hops in a network that respectively includes a sequence of pairs of consecutive network interfaces included in transmitting data from a first path end node of the network path to a second path end node of the network path.

The term “network topology” or “topology”, for short, as used herein refers to a representation of protocol endpoints and/or nodes in a network, and representations of hops representing communicative couplings between and/or among the protocol endpoints and/or nodes in the network. A network may have different network topologies with respect to different network protocols. A network topology may represent physical communicative couplings between nodes in the network. A network topology may represent logical couplings between protocol endpoints and/or nodes of a particular network protocol or a particular type of network protocol.

The domain name system (DNS) of the Internet operates based on an application layer protocol defined by the DNS. The nodes in the DNS are communicatively coupled via the DNS protocol and may be represented by a logical network topology. A DNS system includes nodes connected via the DNS protocol. The DNS system has a network topology defined by nodes that include protocol endpoints of the DNS protocol. In still another example, a token-ring network has a circular topology at the link layer, but may have a star topology at the physical layer.

As used herein, an “entity-specific address space” refers to an address space defined for a specific entity where the addresses in the address space operate as identifiers in the context of the entity. An address from an entity-specific address space is referred to herein as an “entity-specific address”. An address is “entity-specific” in that what it identifies is based on the entity to which it is specific. Another address having the same form and content may identify a different entity when in an address space specific to another entity. Addresses in an entity-specific address space operate as identifiers in the context of an entity to which they are “specific” as defined by the specific association of the address space and the entity. Without knowledge of the entity to which an entity-specific address space is specific, what an address in the entity-specific address space identifies is indeterminate. The terms “entity-specific address” and “entity-specific identifier” are used interchangeably herein. An entity-specific address may identify an entity included in the entity to which the address is specific or may identify an entity external to the entity to which the address is specific. The fact that an address is entity-specific does not define a scope for the address.

A portion of a network is a type of entity. A type of entity-specific address space described herein is a scope-specific address space. As used herein, a “scope-specific address space”, specific to a particular region of a network, is an address space defined for the particular network region, where an address in the scope-specific protocol address operates as identifier, according to a network protocol, of a protocol endpoint in a node outside of the particular region when processed in the context of a node in the particular region. The region is indicated by the span of an indicated scope. The terms “region” and “zone” are used interchangeably herein. An address from a scope-specific address space is referred to herein as a “scope-specific protocol address”. An address is “scope-specific” in that what protocol endpoint it identifies depends on the region to which it is specific. Another address having the exact same form and content may identify a different protocol endpoint when in an address space that is specific to another region. A protocol address in a scope-specific address space serves as an identifier in the context of a node in a region to which the scope-specific address space is “specific” as defined by an association of the address space and the region indicated by the scope. Without knowledge of the particular region to which a scope-specific address space is specific, what a scope-specific protocol address in the scope-specific address space identifies is indeterminate. The terms “scope-specific protocol address” and “scope-specific protocol identifier” are used interchangeably herein. Types of scope-specific address spaces indicating exemplary spans include site-specific, LAN-specific, subnet-specific, city-specific, business-specific, and node-specific.

For a network protocol, an address in a scope-specific address space serves as an identifier of a protocol endpoint in a node. Data may be received via the protocol endpoint from a network via one or more network interfaces that operatively couple the node to the network. Data may be sent via the protocol endpoint to transmit over the network via the one or more network interfaces in the node. Since a protocol endpoint of a network protocol is included in a node and is accessible via a network via a network interface, a protocol address identifying the protocol endpoint also identifies the node and identifies a network interface of the node.

As used herein, a “node-specific address space” is a scope-specific address space defined for a specific node in a network, where the addresses in the node-specific address space operate as identifiers of nodes and/or network interfaces in the network when processed in the context of the specific node. An address from a node-specific address space is referred to herein as a “node-specific address”. An address is “node-specific” in that what it identifies depends on the node to which is defined as specific. Another address having the exact same form and content may identify a different node when in an address space specific to another node. Addresses in a node-specific address space operate as identifiers in the context of a node to which they are “specific” as defined by the specific association of the address space and the node. Without knowledge of the node to which a node-specific address space is specific, addresses in the node-specific address space are indeterminate. The terms “node-specific address” and “node-specific identifier” are used interchangeably herein. A node-specific address space is a type of scope-specific address space.

The term “node” is defined above. Note that an identifier of a network interface in a network also identifies a node that includes the network interface. Thus, a network interface-specific address is also a node-specific address. Network interfaces in a node may have their own respective network interface-specific address spaces that are also node-specific. The network interface-specific address spaces may be combined to form a node-specific address space and/or may be managed as separate address spaces. The adjectives “node-specific” and “network interface-specific” may be used interchangeably.

A scope-specific identifier differs from a scoped address as described in “Request for Comments” (RFC) document RFC 4007 by S. Deering, et al, titled “IPv6 Scoped Address Architecture”, published by the IETF in December, 2006 and further described in application Ser. No. 11/962,285, by the present inventor, filed on 2007 Dec. 21, entitled “Methods and Systems for Sending Information to a zone Included in an Internet Network”. A scoped address space is shared by nodes in a given scope. While a link-local scoped address is specific to a particular node, a link-local scoped address simply identifies a network interface component local to the particular node. A loop-back internet address is specific to a node as well. Neither link-local scoped addresses nor loop-back addresses identify one node to another. As such, neither serves as a node-specific identifier as defined above.

A “scoped address” is described by RFC 3513 and RFC 4007 as an identifier that, in a particular region of a network, serves as a protocol address of a network interface and/or a node in the particular region. The extent of the particular region is referred to as the scope of the region and thus the scope within which the identifier serves as a protocol address. A particular region included within a scope is indicated by its span. A scoped address is a valid protocol address only within a particular region as indicated by the address's indicated scope. Examples of scope indicators include node-scope where identifiers are valid only to a single node in the indicated span, LAN-scope where identifiers are valid for nodes in the span of a particular LAN, and subnet-scope where identifiers are valid only for nodes in a particular subnet. RFC 3513 currently defines support for link-local scope, site-local scope, and global scope. A data unit transmitted with a scoped address should not be delivered to node that does not have a network interface in the span indicated by the scope.

“Path information” is any information that identifies a network path and/or a hop path for data transmitted via one a specified network protocols. Path information may be identified by identifying network interfaces, NICs, nodes, and/or hops included in a network path. “Address information” is any information that identifies a protocol address that, for a network protocol, identifies a protocol endpoint. Address information may identify a unicast protocol address for a network protocol. In identifying a protocol endpoint, a protocol address identifies a node and a network interface.

Those skilled in the art will understand upon reading the descriptions herein that the subject matter disclosed herein is not restricted to the network protocols described and/or their corresponding OSI layers. For ease of illustration, the subject matter is described in terms of protocols that correspond to OSI layer three, also referred to as network layer protocols, in general. Particular descriptions are based on versions of the Internet Protocol (IP). Address information may identify one or more protocol addresses. Exemplary protocol addresses include IP addresses, IPX addresses, DECNet addresses, VINES Internet Protocol addresses, and Datagram Delivery Protocol (DDP) addresses, HTTP URLS, TCP port and IP address pairs, and the like.

The term “path-based address” is defined above. A “node-based address” is a path-based address where some or all of the address includes node identifiers that identify a sequence of nodes in a network path. A “network-interface-based address” is a path-based address where some or all of the address includes identifiers of network interfaces in a sequence in a network path. A “NIC-based address” is a type of network-interface-based address that identifies a sequence of network interface components. A “hop-based address” is a path-based address where some or all of the address identifies one or more hops in a network path. The protocol address types defined are not mutually exclusive.

The term “metric space”, as used herein, refers to a set, as defined in mathematics, where a distance between elements of the set is defined according to a metric. Metric spaces defined in Euclidean geometry are well-known examples. Those skilled in the art of metric spaces, such as Euclidian spaces, will appreciate that a one-to-one mapping may be determined and/or otherwise identified for mapping addresses from a first coordinate space having a first origin for a metric space to addresses from a second coordinate space having a second origin in the metric space. Given a mapping rule between a first scope-specific address space and a second scope-specific address space and a mapping between the second scope-specific address space and a third scope-specific address space based on a third coordinate space identifying a third origin in the metric space, a mapping from the first coordinate space to the third coordinate space may be determined. A mapping between coordinate spaces for a metric space may be included a coordinate shift and/or a rotation, for example. The mapping may be pre-specified and accessible to the nodes in one or both address spaces. Mapping between locations in a number of different metric spaces is well known in mathematics. For example, a top half of the surface of sphere may be mapped to a plane. Some will further appreciate that some metric spaces may be mapped to other metric spaces. Some of these mappings are one-to-one and/or onto.

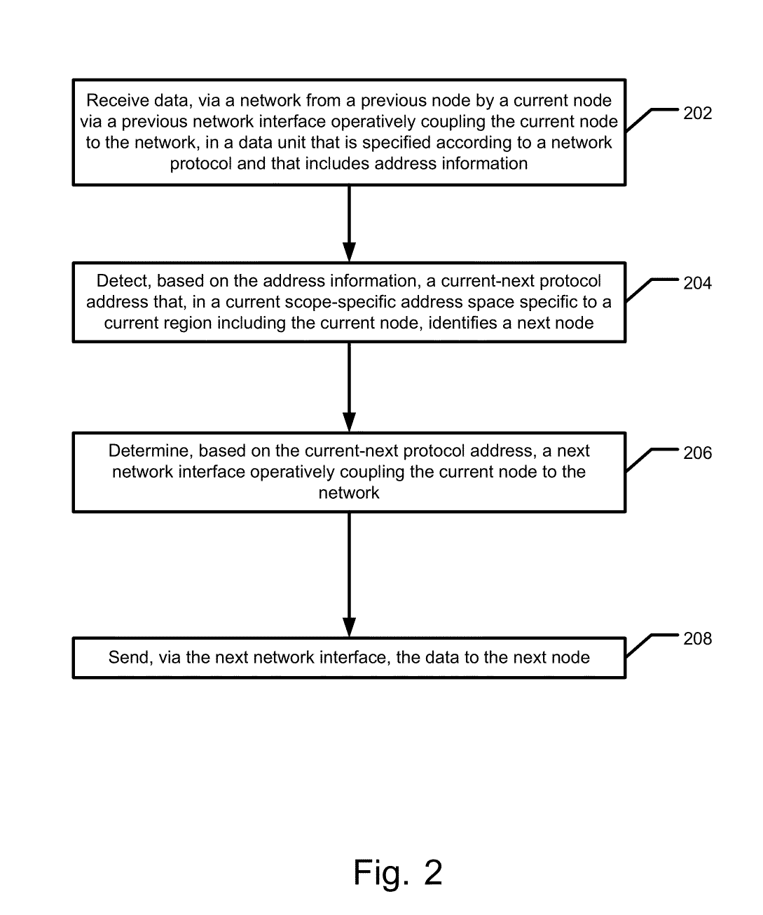

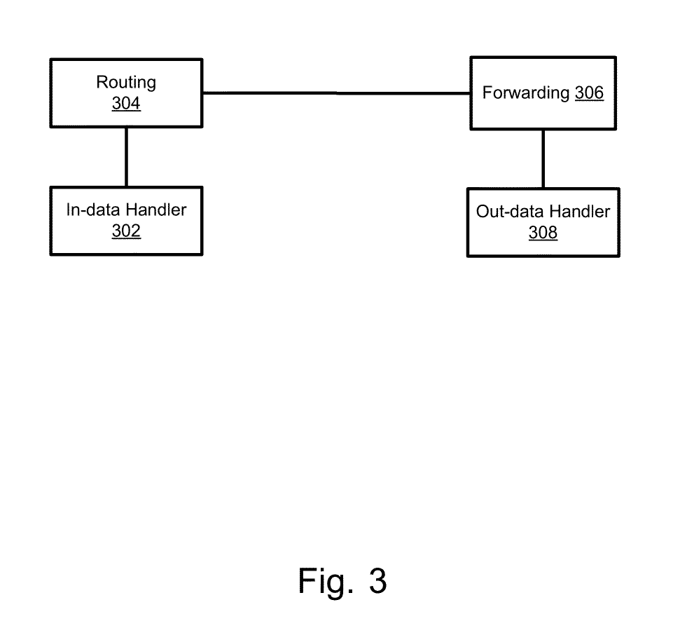

FIG. 3 illustrates an arrangement of components in a system that operates in an execution environment, such as execution environment 102 in FIG. 1. The arrangement of components in the system operates to perform the method illustrated in FIG. 2. The system illustrated includes an in-data handler component 302, a routing component 304, a forwarding component 306, and an out-data handler component 308. The execution environment includes a processor, such as the processor 104, to process an instruction in at least one of the in-data handler component 302, the routing component 304, the forwarding component 306, and the out-data handler component 308.

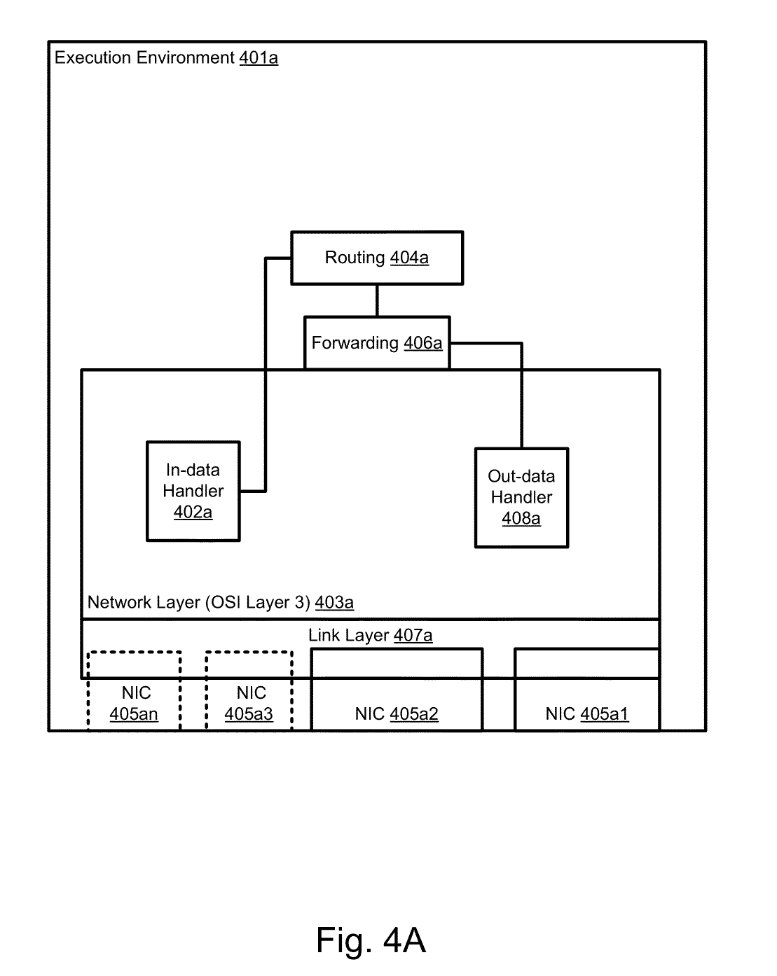

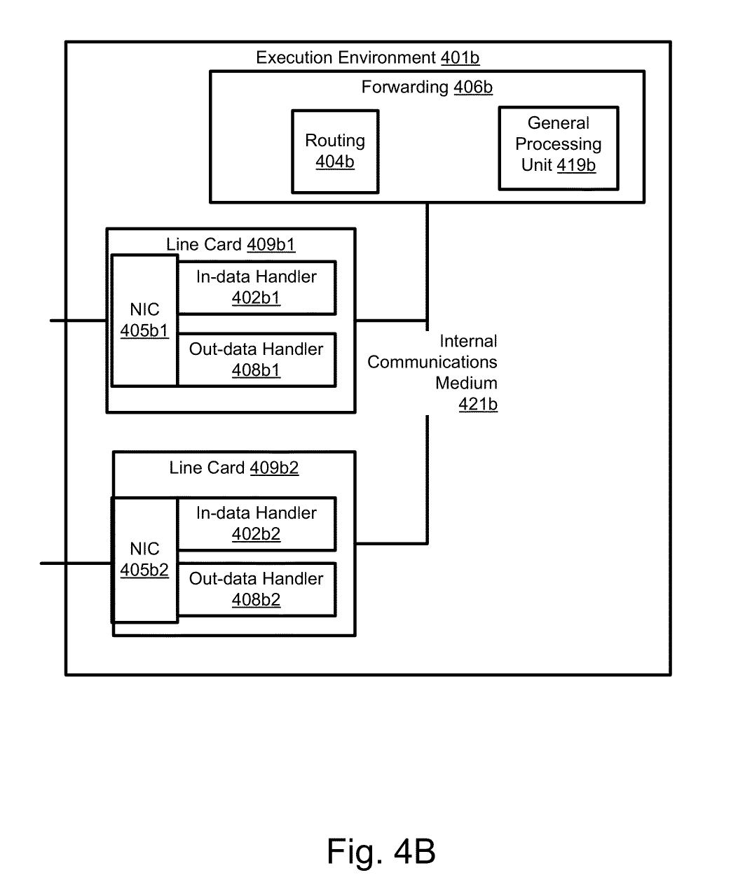

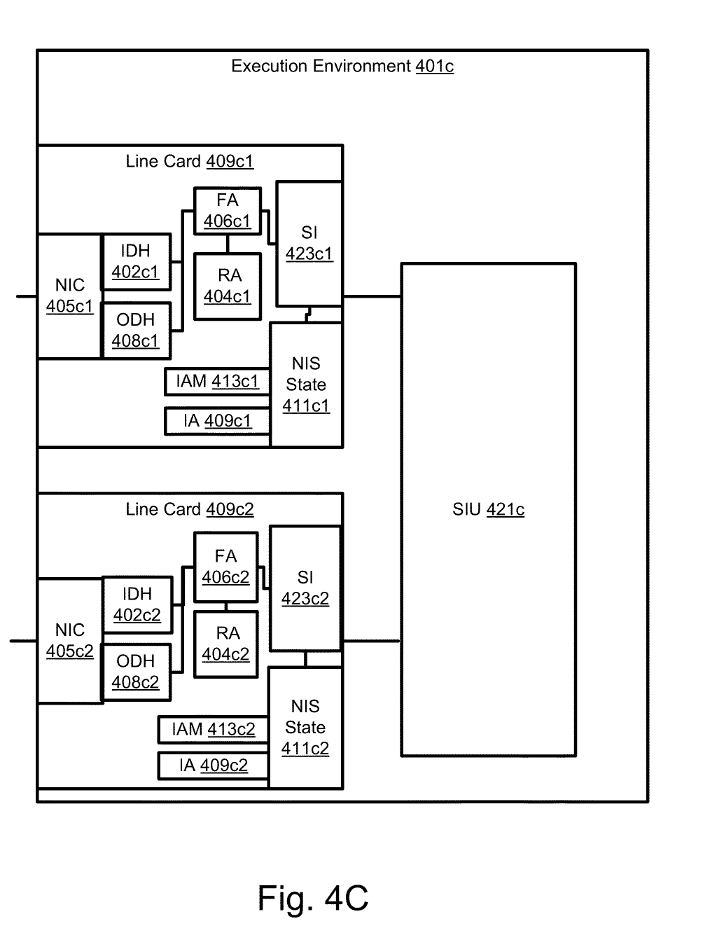

Some or all of the exemplary components illustrated in FIG. 3 may perform the method illustrated in FIG. 2 in a number of execution environments. FIG. 4A, FIG. 4B, and FIG. 4C are each block diagrams illustrating the components of FIG. 3 and/or analogs of the components of FIG. 3 respectively adapted to operate in an execution environment 401a, in an execution environment 401b, and in an execution environment 401c that are included in and/or that otherwise are provided by one or more nodes.

Components, illustrated in FIG. 4A, FIG. 4B, and FIG. 4C, are respectively identified by a number followed with an alphanumeric suffix. A component may be referred to generically in the singular or the plural by dropping a suffix of a portion thereof of the component's identifier. For example, execution environments; such as the execution environment 401a, the execution environment 401b, the execution environment 401c, and their adaptations and analogs; are referred to herein generically as an execution environment 401 or, when describing more than one, execution environments 401. Other components identified with a suffix may similarly be referred to generically or as a group by dropping a suffix or a portion thereof.

FIG. 1 illustrates key components of an exemplary device that may at least partially provide and/or otherwise be included in an execution environment. Some or all of the components illustrated in FIG. 4A, FIG. 4B, and FIG. 4C may be included in or otherwise combined with the components of FIG. 1 to create a variety of arrangements of components according to the subject matter described herein. Those skilled in the art will understand other execution environments in addition to the various adaptations of the execution environments described herein are suitable for hosting an adaptation of the arrangement in FIG. 3.

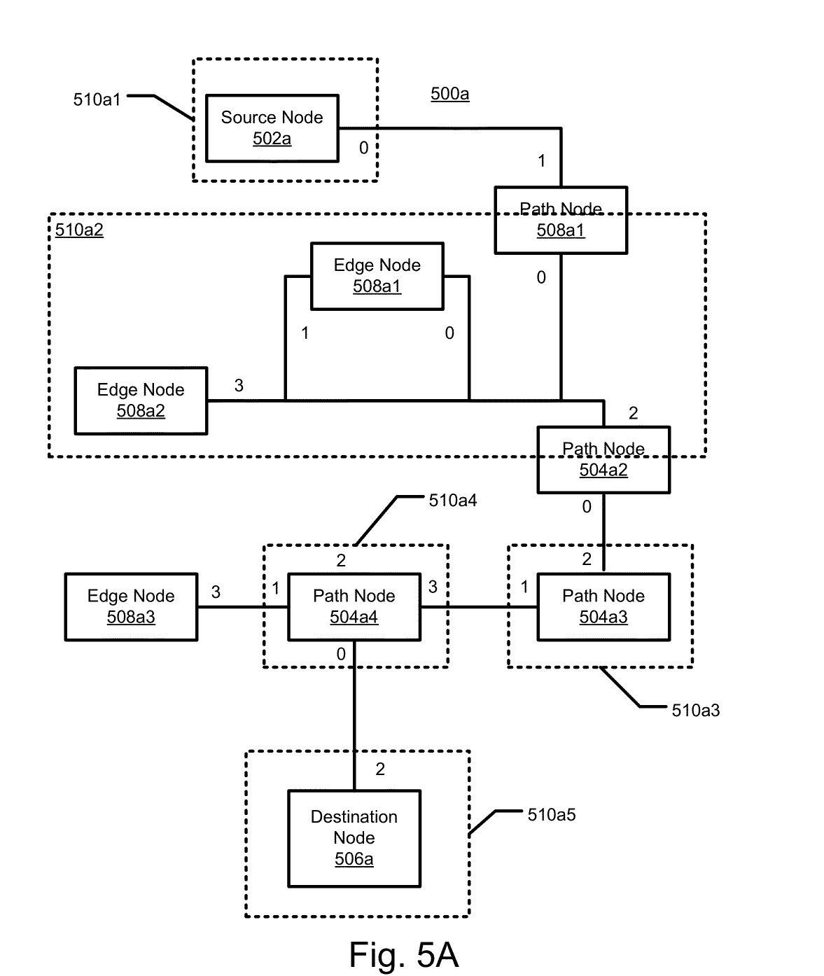

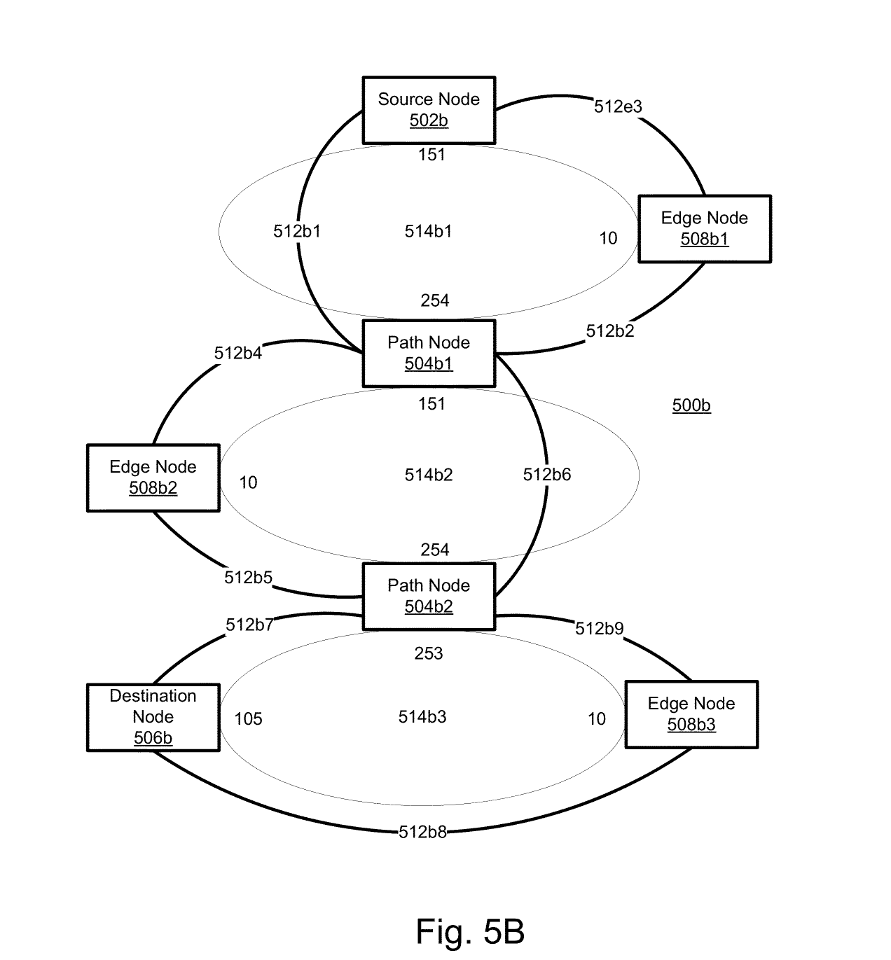

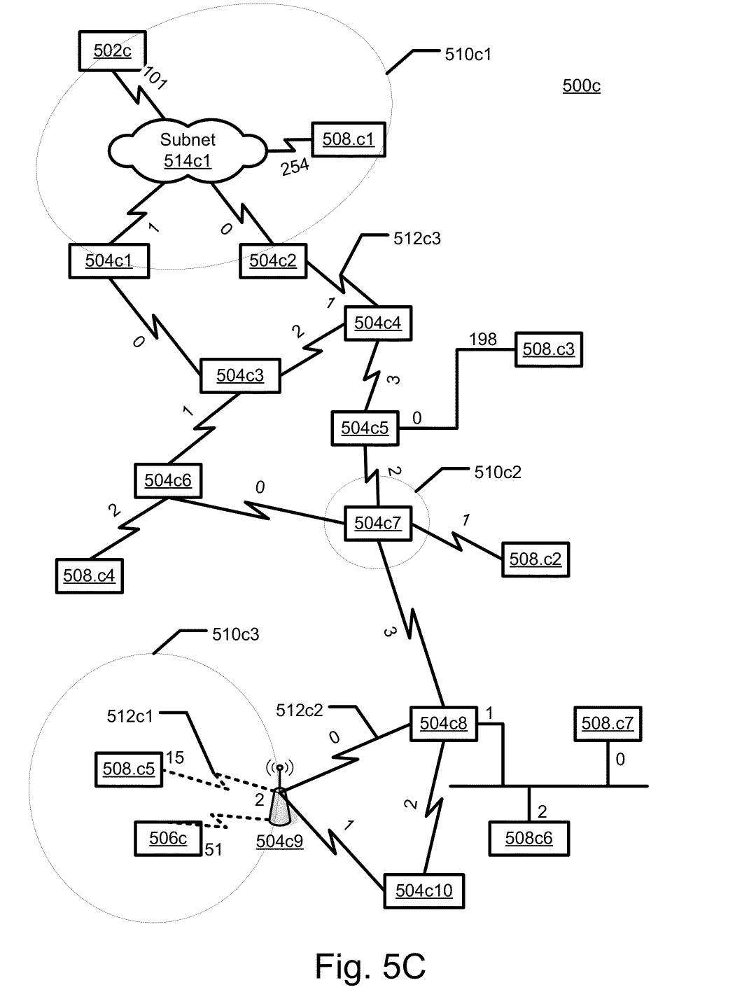

FIGS. 5A-C respectively illustrate networks 500 including nodes that in various aspects may include any of the execution environments 401, illustrated in FIG. 4A, FIG. 4B, and FIG. 4C, their adaptations, and/or their analogs. The various illustrated nodes are operatively coupled via respective network interface components to the respective networks 500 in FIGS. 5A-C. For ease of illustration and description, each of FIGS. 5A-C includes nodes identified by a role played in sending data from one node to another. FIGS. 5A-C illustrate source nodes 502 that in operation initiate a transmission of data to respective recipients, path nodes 504 that in operation relay the data transmitted by respective source nodes 502, and destination nodes 506 identified by the respective source nodes as recipients of the data sent from the source nodes 502. In some of FIGS. 5A-C, one or more edge nodes 508 are illustrated for describing adaptations of the arrangement in FIG. 3 performing various aspects of the method illustrated in FIG. 2 operating in one or more of the roles identified.

A network interface includes one or more NICs identified by a protocol address of a network protocol for sending data from a protocol endpoint identified by the network protocol and/or for receiving data for the protocol endpoint.

In various contexts nodes illustrated as destination nodes 506, edge nodes 508, and/or path nodes 504 may operate as source nodes; some nodes illustrated as source nodes 502, edge nodes 508, and destination nodes 506 may operate as path nodes, and nodes illustrated as source nodes 502, edge nodes, 508, and/or path nodes 504 may operate as destination nodes. Exemplary nodes that operate as path nodes 504 include a router, a switch, a wireless access point, a bridge, a gateway, and the like.

A path node 504 illustrated in any of FIGS. 5A-C and/or a node otherwise operating as a path node may include and/or otherwise may be included in providing an adaptation, analog, and/or instance of any execution environment 401 illustrated in FIG. 4A, FIG. 4B, and/or FIG. 4C. A path node 504 may include a first network interface component and a second network interface component. With respect to FIG. 5B, a first path node 504b1 may be operatively coupled to a first network 514b1 included in a network 500b via a first network interface component, and may be operatively coupled to a second network 514b2 via a second network interface component. The first path node 504b1 may forward data sent from a source node 502b in the first network 514b1 to deliver via a second network 514b2 to a destination node 506b in a third network 514b3. The first network 514b1, the second network 514b2, and/or the third network 514b3 may respectively include and/or may be included in a local area network (LAN), an intranet, at least a portion of the Internet, and/or another wide area network (WAN).

The network components in some nodes may have a layered design or architecture known to those skilled in the art as a “network stack”. Adaptations, analogs, and/or instances of execution environments 401 in FIG. 4A, FIG. 4B, and FIG. 4C may include network components in a layered architecture, physically and/or logically. Other architectural models for network components may be included in other execution environments to send and/or receive data via a network, and are considered within the scope of the subject matter described herein. Combinations of layered architectures and non-layered architectures are also considered to be within the scope of the subject matter described herein.

Some components illustrated in FIG. 4A correspond to components of the layered architecture specified by the Open System Interconnection (OSI) model, known to those skilled in the art. For example network components in FIG. 4A may comply with specifications for protocols included in the TCP/IP protocol suite. The OSI model specifies a seven layer network stack. The TCP/IP protocol suite may be mapped to layer three and layer four of the seven layers. Those skilled in the art will understand that fewer or more layers may be included in various adaptations, analogs, and instances of the execution environments 401 illustrated in FIG. 4A, FIG. 4B, FIG. 4C, and their various aspects described herein; and for any other execution environment suitable for hosting an adaptation, analog, and/or instance of the arrangement of components illustrated in FIG. 3.

FIG. 4A illustrates a network layer component 403a that corresponds to layer 3 of the open systems interconnection reference (OSI) model. The Internet Protocol (IP) is an exemplary layer 3 protocol, also referred to as a network layer protocol. FIG. 4A illustrates a first NIC 405a1 that in operation operatively couples a node including an adaptation, analog, and/or instance of the execution environment 401a to a network. One or more NICs 405a correspond to layer 1, also known as the physical layer, of the OSI model for receiving and sending signals via a physical data transmission medium. Exemplary network layer protocols include an Internet Protocol (IP), DECNet routing Protocol (DRP), an Internetwork Packet Exchange (IPX) protocol, an Internet Datagram Protocol (IDP), a VINES Internet Protocol, and a Datagram Delivery Protocol (DDP).

FIG. 4A also illustrates a link layer component 407a that corresponds to layer 2, also known as the link layer, of the OSI model for communicating, via layer 1, between nodes sharing a physical data transmission medium such as nodes in a LAN. Exemplary link layer protocols include an Ethernet protocol, a Token-ring protocol, and asynchronous transfer mode (ATM) protocol, to name a few. Some or all of a link layer component 407a may be included in one or more NICs 405, as illustrated in FIG. 4A. A portion of a link layer component may be external to and operatively coupled to one or more NICs. The external portion may be realized, at least in part, as a device driver for the one or more NICs. Exemplary physical data transmission media include Ethernet cables of various types, co-axial cables, fiber optic cables, and media suitable for transporting various types of wireless signals. FIG. 4A illustrates that some nodes included in and/or otherwise providing an adaptation, analog, and/or instance of the execution environment 401a may include more than two NICs 405a, as illustrated by a third NIC 405a3 through an Nth NIC 405an.

The network layer component 403a, illustrated in FIG. 4A, may operate to communicate across various types of link layer protocols, in various adaptations. Layer 3 protocols enable data to be exchanged between and among nodes on different networks across different types of physical data transmission media and differing link layer protocols. The Internet Protocol (IP) in the TCP/IP protocol is the most widely utilized network layer protocol currently in use. For ease of illustration, the description that follows provides examples based on IP networks and protocols in the TCP/IP suite due to their wide use and because they are well-known in the art. Those skilled in the art will understand that the scope of the subject matter described is not limited to IP networks.

In addition to the protocols described above, protocols corresponding to layers in the OSI model above the network layer may be included in communicating via a network. The term “application protocol” as used herein refers to any protocol or combination of protocols that correspond to one or more layers in the OSI reference model above the network layer. Programs and executables operating in execution environments 401 may communicate via one or more application protocols. Exemplary application protocols include the transmission control protocol (TCP) in the TCP/IP suite, the user datagram protocol (UDP) in the TCP/IP suite, various versions of hypertext transfer protocol (HTTP), various remote procedure call (RPC) protocols, various instant messaging protocols, various email protocols, and various other protocols for real-time communications. Data exchanged between nodes in a network may be exchanged via data units of one or more network protocols. An execution environment may include layer specific protocol components respectively configured according to the one or more network protocols. Some protocols and/or protocol components may define and/or provide services from multiple layers of the OSI model layer such as the Systems Network Architecture (SNA) protocol.

In addition to specifying schemas defining valid data units, a network protocol may define and/or otherwise be associated with a defined identifier space for identifying protocol endpoints defined according to the network protocol. The terms “identifier space” and “address space” are used interchangeably herein. For example, various versions of hypertext transfer protocol (HTTP) specify a format for HTTP uniform resource locators (URL). HTTP specifies a location in an HTTP header that identifies a URL as an identifier or address from the HTTP address space that identifies both a resource and recipient of an HTTP data unit. The transmission control protocol (TCP) specifies a format and vocabulary for a TCP header including a destination protocol endpoint identifier field referred to as a destination port number that, when combined with a destination protocol address from an IP packet, identifies a transport layer protocol endpoint of a receiver of data sent in a TCP data unit via a network. A source protocol endpoint is similarly identified by a source port number, included in a TCP header as defined by the TCP, along with a source protocol address from an IP data unit as defined by the Internet Protocol.

Other exemplary address spaces that identify protocol endpoints in various network protocols include an email address space, a telephone number address space for various telephony protocols, instant message address spaces for various instant message protocols, and media access control (MAC) addresses for various link layer protocols, to name just a few examples. The address spaces identified are shared among the senders and receivers exchanging data via any particular protocol from among those identified herein as well as others that are known. Some address spaces are shared by senders and receivers in a LAN, an intranet, and/or in another identifiable portion of a network. Other address spaces are shared globally. For example the HTTP identifier space is a global address space shared across the Internet. An HTTP identifier is defined to identify the same resource regardless of the application and/or node identifying the resource via the HTTP identifier. An HTTP URL is a global identifier in an HTTP network, such as the World Wide Web (Web). Addresses in a shared address space are referred to as scoped addresses that serve as identifiers of protocol endpoints in nodes that share the address space in a region of a network defined by a scope.

In delivering data via a network between protocol endpoints of a particular network protocol, addresses from address spaces of the various protocols at the various layers are typically translated and/or otherwise mapped between the various layers. For example, a unicast IP address in an IP packet is mapped to a link layer address for a link via which the IP packet is transported in a network path via a path node 504 in relaying data from a source node 502 to an identified destination node 506. Addresses at the various layers are assigned from a suitable address space for corresponding network protocols.

FIG. 5B illustrates data may be received via a protocol endpoint from a network via one or more network interfaces that operatively couple a node to the network. Data may be sent via a protocol endpoint to transmit over the network via the one or more network interfaces in the node. In FIG. 5B, a network path communicatively coupling the source node 502b and a second edge node 508b2 in the network 500b includes a sequence of nodes including of the source node 502b, a first path node 504b1, and the second edge node 508b2. In FIG. 5C, a first network path communicatively coupling a fifth edge node 508c5 and an eighth path node 504c8 includes a first sequence of nodes including the fifth edge node 508c5, a ninth path node 504c9, and the eighth path node 504c8. The first network path is included in a second network path communicatively coupling the fifth edge node 508c5 and the second edge node 508c2 that includes a second sequence of nodes including of the nodes in the first sequence, a seventh path node 504c7, and the second edge node 508c2. A network path may be physical network path or logical network path based on a particular network protocol defining protocol endpoints in the path end nodes.

FIG. 5B, illustrates a number of network paths communicatively coupling the source node 502b and the destination node 506b in the network. One network path illustrated includes a sequence of hops including a first hop 512b1, a sixth hop 512b6, and a seventh hop 512b7. In FIG. 5C, the first network path described above communicatively coupling the fifth edge node 508c5 and the eighth path node 504c8 includes a first sequence of hops including a first hop 512c1 and a second hop 512c2. A hop may be a physical hop or a logical hop based on a network protocol defining a network topology in which the hop is identified and/or otherwise represented.

In FIG. 5B, the network path described above communicatively coupling the source node 502b and the destination node 506b includes a sequence of network interfaces including a network interface in the first path node 504b1 in the first hop 512b1, a network interface in a second path 504b2 in a sixth hop 512b6, and network interface in the destination node 506b in a seventh hop 512b7. The network paths in FIG. 5C described above may also be described as a sequence of network interfaces.

A network topology may represents logical hops in a network. In FIG. 5B, the first network 514b1 may represented a physical topology when the first 514b1 represents a physical data transmission medium included in physically coupling nodes. The data transmission medium may be a token-ring LAN, for example, The hops 512 in FIG. 5. may illustrate logical communicative couplings at a level of the network above the data transmission medium. The hops 512 may represent network layer hops or hops at some other layer of the network above the physical layer. The domain name system (DNS) of the Internet provides another example of nodes in a logical network topology based on a DNS protocol endpoints of the DNS protocol that identifies nodes in the Internet included the network topology. Hops in a DNS based network topology correspond to communicative couplings enabled by the DNS protocol.

With reference to FIG. 2, a block 202 illustrates that the method includes receiving data, via a network from a previous node by a current node via a previous network interface operatively coupling the current node to the network, in a data unit that is specified according to a network protocol and that includes address information. Accordingly, a system for routing based on a scope-specific address space includes means for receiving data, via a network from a previous node by a current node via a previous network interface operatively coupling the current node to the network, in a data unit that is specified according to a network protocol and that includes address information. For example, the arrangement illustrated in FIG. 3, includes the in-data handler component 302 operable for and/or otherwise included in receiving data, via a network from a previous node by a current node via a previous network interface operatively coupling the current node to the network, in a data unit that is specified according to a network protocol and that includes address information. FIGS. 4A-C illustrate in-data handler components 402 as adaptations and/or analogs of the in-data handler component 302 in FIG. 3. One or more in-data handler components 402 operate in an execution environment 401. In FIG. 4A, an in-data handler component 402a is included in network layer component 403a. In FIG. 4B and in FIG. 4C, in-data handler components 402 operates in respective line card components 409.

In transmitting data from a source protocol endpoint in a source node 502 to a destination protocol endpoint in a destination node 506, the data is processed by a sequence of nodes in a network path that communicatively couples the source node 502 and the destination node 506. A node in the network path that is currently processing the data to send it to the destination 506, is referred to herein as a “current node” with respect to the data. A node in the network path that has previously transmitted the data being processed by the current node is referred to herein as a “previous node”. A node in the network path that has not received the data being processed by the current node is referred to herein as a “next node”. For ease of description, the term “data” with respect to a data unit refers to data sent in one or more data units via a protocol endpoint in the source node being processed by a current node. As such, a source node 502 may be a one of a current node and a previous node with respect to particular data. A path node 504 may be one of a current node, a previous node, and a next node with respect to particular data. A destination node 506 may be one or a next node and a current node with respect to particular data.

A source node 502 may be a current node with respect to data to be transmitted to a destination node 506. The source node 502 may include an adaptation, analog, and/or instance of the execution environment 401a in FIG. 4A. An in-data handler component 402a operating in a network layer component 403a in the source node 502. The network layer component 403a is configured according to a network layer protocol, such as a version of the Internet Protocol. The in-data handler component 402a may detect data in a data unit that is to be sent to the destination node 506. The data may be received from an application component (not shown) that in operation sends data via a network to a recipient. The application component may be an email client, a file transfer application, an network management client, and the like. The in-data handler 402a may receive the data, directly and/or indirectly, from an application component in the source node 502. The in-data handler 402 may interoperate with an out-data component 408a to include and/or otherwise detect the data in a data unit of the network protocol.

A path node 504 may include an adaptation, analog, and/or instance of the execution environment 401a, illustrated in FIG. 4A. Data communicated between a source node 502 and a destination node 506 may be received by the path node 504 via of a first NIC 405a1 operatively coupling the path node 504 to a previous network path including the source node 502 and the path node 504 as path end nodes. One or more link layer protocol data units may be detected by a link layer component 407a according to a compatible link layer protocol. For example, Ethernet frames may be detected as link layer protocol data units when received via a CAT 6 Ethernet cable. Data in a received link layer protocol data unit may be provided to an in-data handler component 402a in a network layer component 403a according to the specification of a particular network layer protocol, such as the IP.

An in-data handler component 402a may detect one or more network layer protocol data units in data received from the link layer component 407a. For example, the in-data handler component 402a may detect one or more IP packets in data received in one or more Ethernet frames. The in-data handler component 402a may detect a network layer data unit that includes data from the source node 502 to relay to the destination node 506 identified by a protocol address in address information in the detected network layer data unit as defined by a particular network layer protocol supported by the network layer component 403a in the path node 504.

A network interface component 405a in a path node 504 may receive data communicated from a source node 502 via a previous network path included in a network 500. One or more network paths may exist to receive the data. A path node 504 may receive data from a source node 502 to transmit the received data to a destination node 506 via a specified protocol. For example, a path node 504 may receive and transmit a data packet at a link layer as performed by an Ethernet bridge and a multi-protocol label switch (MPLS). Further, a path node 504 may receive and transmit a data packet at a network layer as performed by an Internet protocol (IP) router. Still further, a path node 504 may receive and transmit a data packet at an application layer, as defined above.

Accordingly, data from a source node 502 may be included in and/or may include data formatted according a link layer protocol, a network layer protocol, and/or an application layer protocol. An in-data handler component 402a may be configured according to a network layer protocol, a link layer protocol, and/or an application layer protocol.

A network protocol defines one or more of a format defining a valid structure for a data unit and a vocabulary defining valid content of the data unit. For example, data to transmit from a source node to a destination node may be included in a payload portion of a data unit of a particular network protocol. The network protocol may define a format that identifies the payload based on one or more valid data structures for a data unit. For example, a payload portion may be identified by a location with respect to the start of a data unit or relative to another portion of the data unit. Alternatively or additionally, the network protocol may define a vocabulary specifying a keyword, a bit pattern, and/or other detectable marker that when detected identifies a payload or part of a payload in a data unit. The network protocol may define one or more format rules and/or vocabulary rules that an in-data handler component may detect in identifying data and/or address information in a data unit. The term “schema” refers to a definition of a structure and/or a vocabulary for constructing and/or detecting a valid data unit with respect to a network protocol. For example, both an IPv4 data packet and an IPv6 data packet are specified according to a schema for including address information in a destination protocol address field and in a source protocol address field in an IP header based on location and size.

Data received from a source node 502 by a path node 504 may be received via one or more previous path nodes 504. Data may be received by a current node 504 from a previous node based on a previous-current protocol address that, in a previous scope-specific address space specific to a previous region that includes the previous node, identifies the current node as described in detail below.

Returning to FIG. 2, a block 204 illustrates that the method further includes detecting, based on the address information, a current-next protocol address that, in a current scope-specific address space specific to a current region including the current node, identifies a next node. Accordingly, a system for routing based on a scope-specific address space includes means for detecting, based on the address information, a current-next protocol address that, in a current scope-specific address space specific to a current region including the current node, identifies a next node. For example, the arrangement illustrated in FIG. 3, includes the routing component 304 operable for and/or otherwise included in detecting, based on the address information, a current-next protocol address that, in a current scope-specific address space specific to a current region including the current node, identifies a next node. FIGS. 4A-C illustrate routing components 404 as adaptations and/or analogs of the routing component 304 in FIG. 3. One or more routing components 404 operate in an execution environment 401.

In FIG. 4A, a routing component 404a is illustrated as a component of a network layer component 403a. In FIG. 4B, a routing component 404b is illustrated operatively coupled to multiple line card components 409b to relay data between and/or among portions of a network coupled to the line cards 409b. A routing component 404b may operate at a network layer of a network stack and/or at another layer. In FIG. 4C, a routing component 404c is illustrated as distributed throughout line card components 409c of an execution environment 401c. The routing component in the execution environment 401c includes a first routing agent (RA) component 404c1 in a first line card component 409c1 and a second RA component 404c2 in a second line card component 409c2.

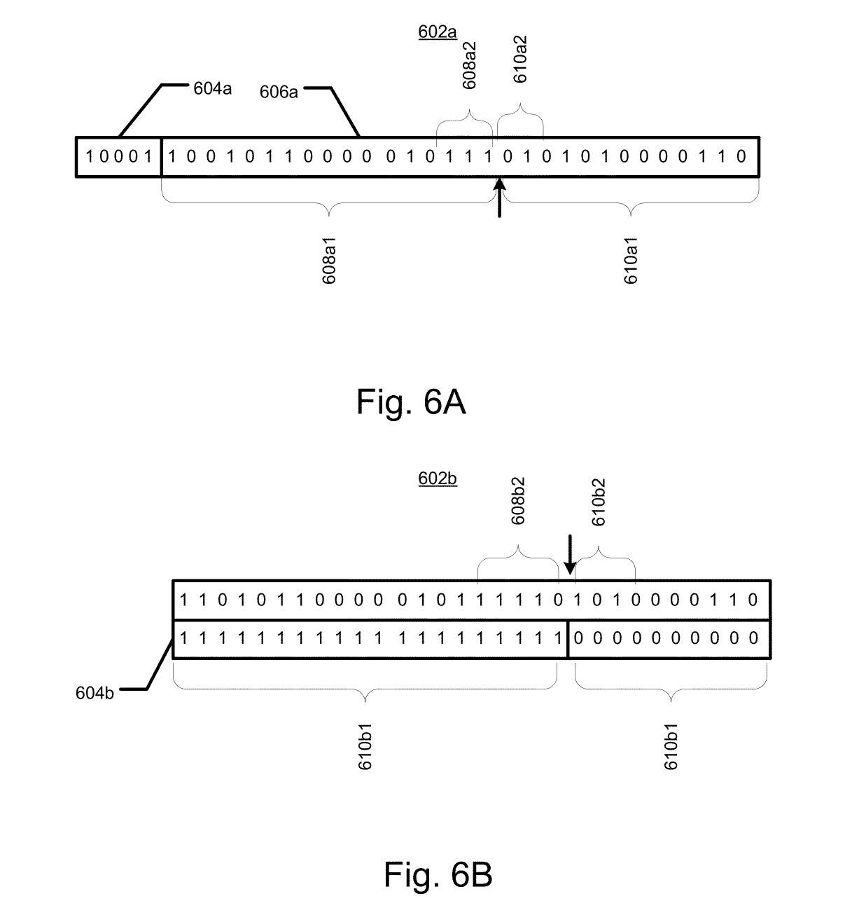

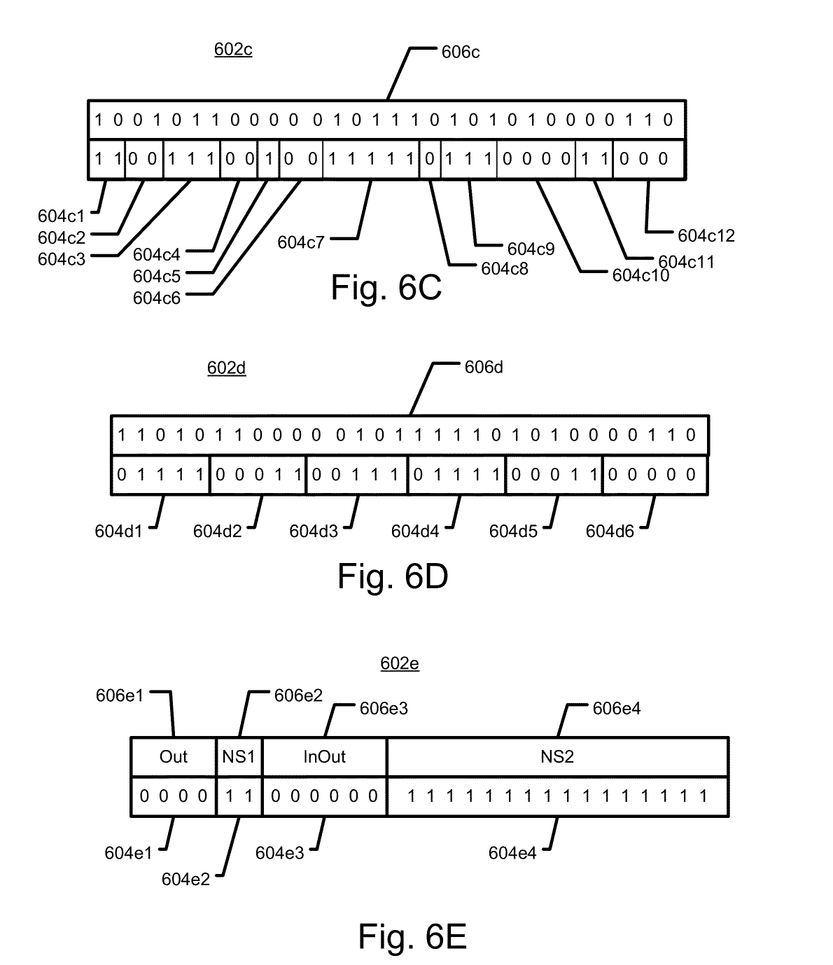

FIGS. 6A-E illustrate a number of types of address representations 602 illustrating aspects of various address formats and vocabularies for representing a scope-specific address. Various portions of the respective address representations 602 are illustrated as contiguous, but need not be so in various embodiments. The address representations 602 in FIGS. 6A-E may be identified based on an aspect of a format of a data unit and/or an aspect of a vocabulary of a data unit as defined by a schema of a network protocol.

Routing component 404a may detect a protocol address of a next node based on a schema for including address information in a data unit of a network protocol. In another aspect, address information may be detected by an in-data handler component 402a that in operation provides some or all of the address information to the routing component 404a to detect a protocol address of a next node.

Address representations 602 in FIGS. 6A-E are described with respect to their inclusion in data units of a network protocol. Each of the address types shown in FIGS. 6A-E may be included in a destination protocol address portion and/or a source protocol address portion of an IPv4 packet header and/or of an IPv6 packet header. Each may be identified as scope-specific, by a routing component 404a, by a bit pattern or identifier defined to identify a protocol address type as a scope-specific address type. The bit pattern or identifier may be located by the routing component 404a stored in a type bits portion of an IP packet and/or in some other specified location. Those skilled in the art will realize that neither the schemas, which define a format rule(s) and/or a vocabulary rule(s) for a protocol address, described nor the protocols in which their use is described are exhaustive.

FIG. 6A illustrates an address representation 602a that may be detected by an in-data handler component 402a and/or a routing component 404a in a data unit or packet of an Internet Protocol or other network layer protocol. An address representation 602a may identify one or more scope-specific addresses for a respective one or more nodes in a network path to transmit data from a source node to a destination node via the network path. In an aspect, an address representation 602a may be processed by an in-data handler component 402a and/or a routing component 404a as including at least three portions. An address separator field 604a is illustrated including a binary number. In FIG. 6A, the exemplary binary number equals seventeen in base ten. The number in the address separator field 604a identifies the size in an address information field 606a of a previous protocol address field to identify the previous protocol address field 608a and a next protocol address field 610a. A routing component 404a, in a current node 504, may process information in a previous protocol address field 608a to identify a previous protocol address that, in a previous protocol address space of a previous node in the network path, identifies the current node 504. A routing component 404a may identify, based on information in a next protocol address field 610a, a next protocol address, that, in a current scope-specific address space of the current node, identifies a next node in the network path. In FIG. 6A previous portion 608a2 may be a scope-specific address of the current node in a region that includes a previous node in a network path from the source node to the current node. A next portion 610a2 may be scope-specific address of a next node to the current node, where the next node is outside a region that includes the current node. The next node follows the current node in a sequence of nodes in a network path including the current node and the destination node.

Alternatively or additionally, a routing component 404a may identify, based on information in a next protocol address field 610a, a current protocol address, that, in a next scope-specific address space specific to a next region that includes the next node, identifies the current node. A routing component 404a interoperating with an in-data handler component 402 may determine a next protocol address, in the current scope-specific address space, that identifies the next node, based on the current protocol address. Further, the next scope-specific address space may be a node-specific address space specific to the next node. In another aspect, a routing component may determine the current protocol address based on the next protocol address.

With respect to FIG. 5A, an address representation 602a may be included in a data unit including data from a source node 502a, in a first region 510a1, to transmit to a destination node 506a. A first scope-specific address space may be specific to the first region 510a1. As described above, the sequence 1.2.2.3.2 may be represented in an address information field 606a to identify a protocol address that, in the first scope-specific address space, identifies the destination node 506a.

In an aspect of the method illustrated in FIG. 2, address information in a data unit may identify a source-destination protocol address that, in a source scope-specific address space specific to a source region that includes a source node, identifies a destination node. Alternatively of additionally the address information may identify a destination-source protocol address that, in a destination scope-specific address space specific to a destination region that includes the destination node, identifies the source node. A current-next protocol address may be included in at least one of the source-destination protocol address and the destination-source protocol address. The current-next protocol address is an address that, in a current scope-specific address space specific to a current region including a current node, identifies a next node with respect to the current node.

At the source node 502a, the address separator field 604a may be set to include a size of zero for a previous protocol address field 608a. The address information field 606a, thus includes a next protocol address field 610a at the source node 502a and identifies the destination node 506a with respect to nodes in the first region 510a1.

At a first path node 504a1, outside the first region 510a1, an address separator field 604a in a data unit including the data from the source node 502a, may include a value of 1 that identifies, in a previous protocol address field 608a, a protocol address that, in the first scope-specific address space specific to the first region 510a1, identifies the first path node 504a1. A routing component 404a in a first path node 504a1 may detect the value. The routing component 404a may also identify, based on the value in the address separator field 604a, a next protocol address field 610a that identifies 2.2.3.2 as a next protocol address that, in a second scope-specific address space specific to a second region 510a2, identifies the destination node 506a. The routing component 404a may detect the next protocol address. Note that, 2.2.3.2, identifies the destination node 506a with respect to all the network interfaces in second region 510a2 to transmit data from a node to the destination interface.

With respect to the destination node 506a, the second path node 504a2 is not considered to be in the second region 510a2 since the network interface in the second path node 504a2 that is included in communicatively coupling the second path node 504a2 to the destination node 506a is not included in the second region 510a2. The first path node 504a1, with respect to the destination node 506a, is included in the second region 510a2 since it has a network interface, in the second region 510a2, that is included in communicatively coupling the first path node 504a1 with the destination node 506a. Similarly, the second path node 504a2 is included in the second region 510a2 with respect to the source node 502a and the first path node 504a1 is not included in the second region 510a2 with respect to the source node 502a.

At the destination node 506a, a data unit including the data from the source node 502a may include a value in an address separator field 604a that indicates that the address information field includes only a previous protocol address field 608a identifying 1.2.2.3.2, which is the destination protocol address when interpreted in the context of the first region 510a1.

In another aspect, the method illustrated in FIG. 2 may include detecting, in a data unit by a current node, address separating information specified according to a network protocol for detecting the next protocol address information and/or the previous protocol address information. The address separating information may be updated to identify, by the next node, at least one of next-previous protocol address information and next-next protocol address information in the address information, wherein the next-previous protocol address information includes information to identify the current node as a previous node. In yet another aspect, address separating information may be updated by a current node to identify, by the current node, the previous protocol address information and the next protocol address information in the address information. As the data from the source node 502a is transmitted from node to node in the network path the value represented in an address separator field 604a in an address representation 602a in a data unit including the data or a portion thereof may be adjusted to identify a protocol address in a suitable address space for the respective nodes in the network path.

In an aspect, at the destination node 506a, the value in the separator address field and/or in another portion of the data unit may be defined to indicate that the address information field 606a also includes information for determining and/or otherwise identifying a protocol address that, in a fifth scope-specific address space specific to a fifth region 510a5 that includes the destination node 506a, identifies a node that has network interface in the first region 510a1. The address information field 606a in some aspects may include information for determining a protocol address that, in the fifth scope-specific address space, identifies the source node 502a.

The above description describes an address representation 602a processed in the role of a destination protocol address in a data unit of a network protocol, such as a version of the internet protocol. An address information field 606a may include source address information sent in data units included in sending data from a source node to a destination node. Returning to FIG. 5A, a data unit including data sent from the source node 502a to the destination node 506a may include source address information in an address information field 606a. At the second path node 504a2, an address separator field may identify a previous protocol address field 608a identifying the sequence 0.0 that identifies a protocol address that, in the second scope-specific address space, identifies the source node 502a to the second path node 504a2. Note that the address 0.0 identifies the source node 502a node to all nodes in the second region 510a2 that communicate with the source node 502a via data units of the network protocol. The address information field 606a including the source address information at the second path node 504a2 may include a next protocol address field 610a, identified by the address separator field 604a, identifying the sequence 0.1.0 that identifies a protocol address that, in the fifth scope-specific address space, identifies the second path node 504a2 to the destination node 506a.

An address handler component 402a may detect address information in a data unit specified according to a network protocol to include a destination protocol address portion and a source protocol address portion as, for example, current IP packet headers are specified. Alternatively, an address handler component 402a may detect address information in a data unit defined to include an address portion that identifies a source protocol address that identifies a source node in the context of a scope-specific address space specific to a region including a destination node and identifies a destination protocol address that identifies the destination node in the context of another scope specific address space specified to another region including the source node. The Internet Protocol may include a schema defining such as data unit as a valid IP packet. Rather than requiring separate source and destination portions, as current IP packet headers require, a single address portion may include address information that identifies a protocol address that is a destination protocol address in one scope-specific address space and a protocol address that is a source protocol address in another. More details as well as examples are described below.

FIG. 6b illustrates a variant of the address type illustrated in FIG. 6A. Instead of or in addition to including an address separator field that distinguishes a previous protocol address field from a next protocol address field based on a size, a bit-mask may be specified as one or more address separator fields 604b to identify a previous protocol address field 608b and a next protocol address field 610b in an address information field 606b in an address representation 602b of a data unit formatted according to a particular network protocol, such as IP or IPX. Address information formatted as illustrated in FIG. 6B may be processed by a routing component 404a interoperating with an in-data handler component 402a in an analogous manner to that described for the address information in FIG. 6A based on the bit mask address separator field(s) 604b rather than and/or in addition to a size address separator field 604a illustrated in FIG. 6A.

As described above and further described below, address information may be based on path information for a network path included in communicatively coupling a pair of nodes in a network. Detecting address information may include determining path information identifying a network path included in communicatively coupling a source node and a destination node. Address information may include and/or otherwise identify the path information.

FIG. 6C illustrates an address representation 602c identifying path information that may be detected by a routing component 404a. An address information field 606c may be interpreted as a network path identifier based on address separator field(s) 604c in a data unit. Address separator fields are specified according to a network protocol to distinguish one path identifier from another path identifier in an address information field 606c.

In one aspect, illustrated in FIG. 6C, a routing component 404a and/or a an in-data handler component 402a may distinguish hop identifiers, since a single hop is a network path. A routing component 404a may distinguish separate hop identifiers based on changes in values in bits of consecutive address separator fields 604c. In FIG. 6C, a first address separator field 604c1 includes one or more 1-valued bits that correspond to bit positions in the address information field 606c to identify a previous protocol address field referred to in FIG. 6C as a first hop information field. Network paths that include more than one hop may be distinguished similarly as shown in FIG. 6B. Combinations of hop identifiers and path identifiers may be distinguished by a routing component 404a and/or an in-data handler component 402a based on information in address separator fields 604 A second hop information field 604c2, in FIG. 6C, includes two 0-valued bits to identify a second hop information field in address information field 606c. Additional alternating sequences of 1-valued bits and 0-valued bits illustrated by address separator fields 604c3-12c correspond to and identify other hop information fields identifying hops in a network path communicatively coupling a source node 502 and a destination node 506.

Address information may include path information identifying a network path. Path information may include hop information identifying a hop. Next protocol address information may be defined by a network protocol to include next path information identifying a next network path included in communicatively coupling a current node and destination node. Alternatively or additionally, previous protocol address information may be defined by the network protocol to include previous path information identifying a previous network path included in communicatively coupling the current node and the source node. Next path information may include next hop information identifying a hop in the next network path. Previous path information may include previous hop information identifying a hop in the previous network path.

In FIG. 5C, a hop may be identified by an interface identifier that may identify directly and/or indirectly one or more network interfaces in a pair of communicatively coupled nodes included in the hop. For example, the number 1 may serve as a hop identifier specific to a second path node 504c2 to identify a third hop 512c3 including the second path node 504c2 and a fourth path node 504c4. The number 1 may also identifies a network path for exchanging data between the two nodes. The number 1 may also be a protocol address that, in a scope-specific address space specific to a region that includes the network interface of the second path node 504c2 included in the third hop 512c3, identifies the fourth path node 504c4. The number 1 may also identify a hop for the fourth path node 504c4 to exchange data with the second path node 504c2 and may also be a protocol address that, in a scope-specific address space specific a region that includes the network interface of the fourth path node 504c4 included in the third hop 512c3, identifies the second path node 504c2 and identifies a particular network interface of the second path node 504c2.

A source node 502c may identify a destination node 506c by a destination protocol address that, in a first scope-specific address space specific to a first region 510c1 including the source node 502c, identifies the destination node 506c. The protocol address may be based on a sequence of hop identifiers 0.1.3.2.3.0.51. Note that other network paths are illustrated to transmit data from the source node 502c to the destination node 506c and may also identify protocol addresses in the first scope-specific address space that identify the destination node 506c to nodes in the first region 510c1.

A seventh path node 504c7 in the identified network path may identify the destination node 506c based on another sequence of hop identifiers 3.0.51. The sequence of hop identifiers may identify a protocol address that, in a second scope-specific address space specific to a second region 510c2 that includes the seventh path node 504c7, identifies the destination node 506c. Note that a routing component 404a operating in the seventh path node 504c7 may detect the sequence 3.0.51, in and/or otherwise based on the protocol address of the destination node 506c from the first scope-specific address space. Further, the routing component 404a may detect a protocol address for the eighth path node 504c8 as well as a protocol address for the ninth path node 504c4, in and/or otherwise based on the sequence 3.0.51. The detected protocol addresses are specific to the second region 510c2 as illustrated in FIG. 5c.

The destination node 506c is in a third region 510c3. Within the third region 510c3 the destination node 506c may be identified by a local-scoped address 51. Nodes in the third region 510c3 may identify nodes outside the third region 510c3 with identifiers from a third scope-specific address space specific to the third region 510c3 while using local-scoped addresses to identify nodes in the third region 510c3.

The hop identifiers 0.1.3.2.3.0.51 may be represented in an address representation 602c in a data unit to send data from the source node 502c to the destination node 506c. At the seventh path node 504c7, a routing component 404a may determine and/or otherwise detect a protocol address of a next node based on a next protocol address field identifying the sequence 3.0.51. The identifiers may be given a bit or binary representation and the hop identifiers may be distinguished or separated via address separator fields 604c as described above with respect to FIG. 6C. An address separator field analogous to that shown in FIG. 6A may also be included and processed as described above. Assignment of hop identifiers is described in application Ser. No. 13/727,649 (Docket No DRV0026) filed on 2012 Dec. 27, entitled “Methods, Systems, and Computer Program Products for Assigning an Interface Identifier to a Network Interface”, and application Ser. No. 13/727,655 (Docket No DRV0030) filed on 2012 Dec. 27, entitled “Methods, Systems, and Computer Program Products for Determining a Shared identifier for a Hop in a Network”.

Note that the address information that identifies one or more protocol addresses for the seventh path node 504c7 and for the destination node 506c in the preceding description may include information to identify a return path or a portion thereof. For example, the sequence address 3.0.51 identifies 0.3 which may be a part of a protocol address that, in the third scope-specific address space identifies the seventh path node 504c. And may be protocol address that identifies the seventh path node 504c7 for the ninth path node 504c9 operating as a gateway for nodes in the third region 510c3. The sequence 0.1.3.2 identifies 2.3.1 that, in the second-node-specific address space identifies a network path from the seventh path node 504c7 to the a node having a network interface in first region 510c1, illustrated by a second path node 504c2. The second region 510c2 may include only one node, thus the second scope-specific address space may be a node-specific address space. A current scope-specific address space for a current node may be a node-specific address space specific to the current node.

While the sequence 2.3.1 is an identifier in the second scope-specific address space, it does not identify any network interfaces of nodes in the first region 510c1. Separate source address information may be included in a data unit received by the seventh path node 504c7 that includes data sent from the source node 502c. Address information in the data unit may include a source protocol address representation 602c that may identify 2.3.1.101 as a protocol address that, in the second node-specific address space identifies the source node 502c. Note that 101 may identify a hop in the first region 510c1 from the second path node 504c2 to the source node 502c, in some aspects. For example, subnet 514c1 may be a LAN. In another aspect, 101 may be a scoped address that identifies the source node 502c in the scope of the first region 510c2. Thus a scope-specific protocol address may include a scoped address.

As described in the previous paragraph, a hop may be assigned an identifier that is shared by the pair of nodes in the hop. Thus a sequence of hop identifiers may serve as a scope-specific address in one scope-specific address space when processed in one order of the sequence and may serve as another scope-specific address specific to another node when processed according to another order of the sequence. Any of the address types illustrated in FIGS. 6A-C, along with various variants and analogs, are suitable for including reversible address information.

FIG. 6D includes an address representation 602d illustrating a schema for representing path information based on identifiers of network interfaces included in a hop and/or path end nodes in a network path. A routing component 404a and/or an in-data handler component 402a may operate based on the schema or a portion of the schema. An address information field 606d includes path information for identifying a network communicatively coupling a pair of path end nodes in a network path. FIG. 6D illustrates that an address representation 602d may include one or more address separator fields 604d that correspond to and/or otherwise identify respective one or more portions of the address information field 606d that are based on one or more pairs of identifiers of network interfaces of path end nodes. An address separator field 604c includes series of 1-valued bits and 0-valued bits. A change from a 1-valued bit to a 0-valued bit and vice versa may indicate, to a routing component 404a and/or an in-data handler component 402a, a boundary separating interface identifiers. Since a network path may consist of a single hop, a pair of interface identifiers corresponding to an address separator portion 604c may identify network interfaces in a hop in a network path. An address separator field 604d1 includes one 0-valued bit followed by four 1-valued bits. The 0-valued bit may be defined to indicate that a first network interface in a first hop identifier is 1 bit long with a corresponding position in the address information field 606d. FIG. 6D identifies the first interface identifier as the number 1 in base ten. The four 1-valued bits in the first address separator field 604d1 may be similarly defined to identify the location of a second interface identifier in the first hop identifier. The second interface identifier, as illustrated in FIG. 6D, has the value 10 in base ten. The first hop identifier includes the numbers 1 and 10. A second hop identifier is located by the end of the series of four 1-valued bits in the first address separator field 604d1 to a series of three 0-valued bits that identify a boundary of a second address separator field 604d2 for second hop information identifying a second hop identifier, and the three O-valued bits also identify the location of a first interface identifier in second hop information in the address information field 606d. Two subsequent 1-valued bits identify the location in the address field 606d of a second interface identifier in the second hop information. The second hop identifier includes the numbers 6 and 0 in base ten. The remaining address separator fields 604d may be processed similarly.

The protocol address illustrated FIG. 6D may be represented textually as 1-10.6-0.0-5.1-14.5-0.6. Note that the last hop mask does not include a pair of identifiers and is similar to address portions identified based on address separator fields 604c described with respect to FIG. 6C, and may be a local-scoped address. This is illustrated to demonstrate that protocol addresses may be uniform or non-uniform in their format and content. FIG. 6D illustrates that hop identifiers may be scope-specific hop identifiers and thus each hop identifier serves to identify a next node in the context of a path node a network path identified the hop and/or path identifiers, and also may serve to identify a previous node for a path node in the network path. As such its format and vocabulary the identifiers included in an address information field 606d may be scope-specific.

In FIG. 5B, a source node 502b may identify a destination node 506b by a destination protocol address in a source node-specific address space specific to the source node, where the protocol address is based on pairs of network interfaces identifiers as described in the previous paragraphs. For example, FIG. 5B illustrates a sequence of pairs of interface identifiers 151-254.151-254.253-105 may be a protocol address that, in the source node-specific address space, identifies the destination node 506b. The source node 502b may send a data unit including an address representation 602d illustrated in FIG. 6D. Note that reversing the interface identifiers yields the identifier 105-253.254-151.254-151 that may be a protocol address that, in a destination node-specific address space specific to the destination node 506b, identifies the source node 502b.

For a first path node 504b1, an address representation 602d in a data unit including data received from the source node 502b may include previous protocol address information identified by a routing component 404a based on one or more address separator fields 604 that identifies the 151-254 and/or that identifies the sequence 254-151. The sequence order as 151-254 may identify a protocol address that, in the source node-specific address space, identifies the first path node 504b1. The sequenced ordered as 254-151 may identify a protocol address that, in a first path node-specific address space specific to the first path node 504b1, identifies the source node.

Further for the first path node 504b1, the address representation 602d may include next protocol address information identified by the routing component 404a based on one or more address separator fields 604d that identify the sequence 151-254.253-105 in a first order and/or in a second order. The sequence 151-254.253-105 in the first order may identify a protocol address that, in the first path node-specific address space, identifies the destination node 506b. The sequence 105-253.254-151 in the second order may identify a protocol address that, in the destination node-specific address space, identifies the first path node 504b1.

Still further, for the first path node 504b1, the next protocol address information identified by the routing component 404a identifies the sequence 151-254 in a first order and/or in a second order. The sequence 151-254 in the first order may identify a protocol address that, in the first path node-specific address space, identifies a second path node 504b2 in a network path to the destination node 506b. The sequence 254-151 in the second order may identify a protocol address that, in a second path node-specific address space specific to the second path node 504b2, identifies the first path node 504b1.

A sequence of hop identifiers based on interface identifiers may serve as a scope-specific address in one scope-specific address space when processed in one order of the sequence and may serve as another scope-specific address specific to another node when processed according to another order of the sequence.

FIG. 6E illustrates an address representation 602e that further demonstrates that an address handler component 404a may detect a protocol address, of a next node, in a protocol address based on path information and/or based on address information that does not identify a network path. An address representation 602e may include portions that include path information and/or portions that include scoped protocol addresses. A routing component 404a may distinguish protocol address portions based on address separator fields 604e. Address separator fields 604e may be defined to identify protocol address portions in a manner similar to the method described for distinguishing hop identifiers in FIG. 6C. A previous protocol address information field 606e1, in FIG. 6E, corresponding to a first address separator field 604e1 includes a single interface identifier for an outbound network interface for the source node 502c as described above with respect to FIG. 6A and FIG. 5C. A next protocol address information field 606e2 corresponding to a second address separator field 604e2 may include a scoped protocol address having an inside scope, an outside scope, or both. A node processing the second address information field 606e2 may be included in a portion of a network spanned by the scope of the scoped protocol address. The node may process the scoped protocol address accordingly. See application Ser. No. 11/962,285, by the present inventor, filed on 2007 Dec. 21, entitled “Methods and Systems for Sending Information to a Zone Included in an Internet Network” for a description of addresses having outside scope and/or inside scope and processing of such addresses. A third address information field 606e3 corresponding to a third address separator field 604e3 may include a pair of identifiers as described with respect to FIG. 6D. A fourth address information field 606e4 corresponding to a fourth address separator field 604e4 may include a protocol address analogous to one of the types of addresses described with respect to the next protocol address information field 606e2 such as an local-scoped address.

FIG. 6e illustrates that a scope-specific protocol address specific to a node may include addresses and/or portions of addresses that are not from a scope-specific address space.

In FIG. 5B, the source node 502b may be included in a first region that includes network interfaces coupling nodes to a first network 514b1 included in a network 500b. A destination node 506b may be included in a third region that includes network interfaces coupling nodes to a third network 514b3. Each of the two nodes may identify the other by a protocol address in respective scope-specific address spaces. For example, a sequence of local-scoped addresses 254.254.105 may be a protocol address that, in a first scope-specific address space specific to the first network 514b1, may identify the destination node 506b to the source node 502b, as well as to other nodes in the first region defined by the first network 514b1. A data unit including an address representation 602e in FIG. 6E may identify a scope-specific protocol address based on a sequence of scoped addresses.

For a second path node 504b2, an address representation 602e in a data unit including data received from the source node 502b may include previous protocol address information identified by a routing component 404a in the second path node 504b2 based on one or more address separator fields 604e that identifies previous sequence 254.254 in previous protocol address information in the address representation 602e. The previous sequence may identify a protocol address that, in the first scope-specific address space, identifies the second path node 504b2.

Further, for the second path node 504b2, the previous protocol address information identified by a routing component 404a in the second path node 504b2 identifies a first scoped address 254 that, in the scope of the second network 514b2 identifies a network interface of the second path node 504b2 to nodes with network interfaces in the second network 514b2.

Yet further for the second path node 504b2, the address representation 602e may include next protocol address information identified by the routing component 404a in the second path node 504b2 based on one or more address separator fields 604e that identifies a scoped address 105. The scoped address 105 in the scope of the third network 514b3 identifies the destination node 506b to nodes with network interfaces in the third network 514b3, such as the second path node 504b2.

In still another aspect, a scope-specific address may conform to a currently known schema defining a valid Internet Protocol address as specified by RFC 791 and/or RFC 3513 in a scope-specific address spaces specific to a region. The scope-specific address is processed as scope-specific as opposed to interpreting it as included in a global address space as is currently done. In one aspect, a mapping may be specified between two scope-specific address space. In another aspect, a mapping may be specified from a scope-specific address space to a global address space. A mapping may be ruled-based and/or may be specified by associations such as represented by a lookup table.

A routing component 404a in a current node 504 may detect first address information identifying a current-first protocol address that, in a current scope-specific address space specific to a current region that includes the current node 504, identifies a first node in the network. Second address information identifying a first-second protocol address that, in a first scope-specific address space specific to a first region that includes the first node, identifies a second node in a network path including the current node to transmit data from a source node 502 and an identified destination node 506. The routing component 404a operating in the current node 504 may detect a relationship between the current-first protocol address and the first-second protocol address. The routing component 404a may generate a first-to-current mapping rule based on the relationship. The routing component 404a may process the first-second protocol address based on the first-to-current mapping rule to determine a current-second protocol address that, in the current scope-specific address space, identifies the second node in the network path. The second node may be a next node with respect to the current node 504 and the data from the source node 502. The second node may be the destination node 506.

A current-first protocol address 10.22.106.3 from a current scope-specific address space, may serve as an identifier with respect to the current node of a first node in the network. A first-second protocol address 40.88.58.1 in a first scope-specific address space, may serve as an identifier with respect to the first node of a second node. The current-first protocol address and first-second protocol address, in the example, include four parts. A first-first protocol address may be represented as 0.0.0.0 that, in the first scope-specific address spaces identifies the first node. A routing component 404 in the current node 504 may determine that the current-second protocol address, in the current scope-specific address space, for the second node may be calculated based on the mapping rule represented here as 40+10 mod 256.88+22 mod 256.106+58/mod 256.3+1mod/256, or 50.110.164.4.

The mapping rule may be specific to the current scope-specific address space and the second scope-specific address space, may be specific to an identified group of scope-specific address spaces specific to a respective group of regions, and/or may apply among all scope-specific address spaces in use by nodes in a network. Those skilled in the art will see given the examples than many mapping rules exist that allow protocol addresses to be determined from previous protocol address information and next protocol address information according to the method illustrated in FIG. 2.

In an aspect, a current scope-specific address space may include identifiers that identify locations, in a multi-dimensional metric space, that is defined based on a plurality of axes that intersect at a current-origin location in the metric space The current location may represent a node in the current scope-specific address space. A network interface of the node at the current-origin location may be identified based on an axis in the plurality of axes. The current-next protocol address may be detected relative to a current-origin address that, in the current scope-specific address space, identifies the current-origin location in the metric space, wherein the current-next protocol address identifies a next location in the metric space relative to the current-origin location and the next location represents the next node.

In a related aspect, a current node 504, in a network path to transmit data from a source node 502 to a destination node 506, may be in a current region that has a current scope-specific address space. The current scope-specific address space may include an origin address, such as address 0.0.0.0, that identifies a network interface of a node in the network identifying an origin node and/or an origin network interface. Protocol addresses in the current scope-specific address space that identify other network interfaces and/or nodes may be defined relative to the origin address based on a specified mapping rule that is defined based on a relationship between the origin node and other network interfaces and/or nodes in the network. The mapping rule may be based on a metric and represented in a network topology of the network.

A mapping rule between a current node-specific address space of a current node and next scope-specific address space specific to a next node may be determined based on an current origin protocol address in the current scope-specific address space a current-next protocol address in the next scope-specific address space that identifies the current node, and a protocol address in the current scope-specific address space of an origin network interface and/or origin node in the next region.

The mapping rule may specify a coordinate shift and/or a rotation about an axis, for example. The mapping may be pre-specified and accessible to the current node in one aspect. In another the current node may determine the mapping based on one or more detected relationships between pairs of protocol addresses respectively from the two scope-specific addresses spaces of the current node and the next node where a protocol address from each of the address spaces that identifies a same node is known to the current node.

Exemplary metric spaces include Euclidean spaces, non-Euclidean spaces, geo-spaces, and other geometric spaces. A Cartesian coordinate system is an exemplary address space for a Euclidean space. Another example of a geometric address space is a geospatial address space such as used currently in geo-location services. Networks have topologies that may be represented in a geo-space including locations addressed via addresses in a geometric address space.

As described various types of protocol addresses may conform to various schemas defining rules for formatting valid protocol addresses and/or defining vocabularies specifying valid content of a protocol address. Given a current node in a network path to transmit data from a source node to a destination node, the current node may identify a next protocol address and/or a previous protocol address that are scope-specific protocol addresses according to various aspects as described above, and their analogs and extensions.

A next protocol address and/or a previous protocol address may be determined and/or otherwise identified based on one or more of a schema of one or more of a destination protocol address and/or a source protocol address identified in an address information portion of a data unit, a schema of a scope-specific hop identifier, a mapping between two or more of the schemas or portions thereof of two or more respective scope-specific address spaces, relationships between the nodes to which the protocol addresses are specific, relationships between the scope-specific address spaces of the protocol addresses, and relationships between the nodes in a network that includes them. Some of the relationships listed may be represented in a network topology of the network. A routing component 404 may detect some or all of the network topology in determining a next protocol address and/or a previous protocol address.

Returning to FIG. 2, a block 206 illustrates that the method yet further includes determining, based on the current-next protocol address, a next network interface operatively coupling the current node to the network. Accordingly, a system for routing based on a scope-specific address space includes means for determining, based on the current-next protocol address, a next network interface operatively coupling the current node to the network. For example, the arrangement illustrated in FIG. 3, includes the forwarding component 306 operable for and/or otherwise included in determining, based on the current-next protocol address, a next network interface operatively coupling the current node to the network. FIGS. 4A-C illustrate forwarding components 406 as adaptations and/or analogs of the forwarding component 306 in FIG. 3. One or more forwarding components 406 operate in an execution environment 401.

In FIG. 4A, a routing component 404a may provide a next protocol address of a next node and/or forwarding information based on the next protocol address to a forwarding component 406a to determine a network interface to send data from a source node 502 to a destination node 506 via a next node in a network path from a current node 504 including the forwarding component 406a. In FIG. 4A, a forwarding component 406a is illustrated operatively coupled to a network layer component 403a and operatively coupled to the routing component 404a.

In an aspect, determining a next network interface based on a protocol address of a next node may include detecting an interface identifier in the protocol address. In FIG. 5C, data in a data unit may be received by the seventh path node 504c7 from the source node 502c. Address information in the data unit may identify the destination node 506c via a protocol address 0.1.3.2.3.0.51 representing a sequence of hops in a network path including the source node 502c and the destination node 506c. As described above, the routing component may determine that a protocol address based on the sequence 3.0.51 in the second scope-specific address space, identifies the destination node 506c. Further, the hop identifier 3 may identify, in the second scope-specific address space, the eighth path node 504c8 as a next node. The number 3, as described above is assigned to identify a hop including the seventh path seventh path node 504c7 and the eighth path node, and thus identifies a network interface, in the seventh path node 504c7, that is included in the hop.

Identifying a next network interface may include performing a mapping and/or lookup that maps a portion of a protocol address of a next node to an identifier that identifies a NIC 405a to a link layer component 407a. A next network interface may be identified by mapping a network layer address to a link layer address by means of a lookup table or record associating the network layer address with the link layer address.

For scope-specific protocol addresses that do not include an identifier of a next node, a similar lookup operation may be performed. In an aspect, a scope-specific address may be mapped to another address space such as global protocol address space or subnet-specific protocol address space shared by nodes in a portion of a network such as a LAN and/or a sub-network. Performing a mapping operation may reduce the number of lookup tables and/or records that must be maintained and/or otherwise accessed.

Protocol addresses illustrated in FIGS. 6A-E may include identifiers from scope-specific address spaces that identify a next node. In some aspects, a protocol address of next node includes an identifier of a network interface to transmit data to a destination protocol address via a network path that includes a next node identified by the protocol address. Routing tables and/or routing policies are not required when protocol addresses include identifiers of next nodes. In some aspects, routing tables and routing policies may be supported to support addresses from a global protocol address space and may be supported when a hop identifier identifies a pair of nodes in a network path that are communicatively coupled via one or more other path nodes.

Returning to FIG. 2, a block 208 illustrates that the method yet further includes sending, via the next network interface, the data to the next node. Accordingly, a system for routing based on a scope-specific address space includes means for sending, via the next network interface, the data to the next node. For example, the arrangement illustrated in FIG. 3, includes the out-data handler component 308 operable for and/or otherwise included in sending, via the next network interface, the data to the next node. FIGS. 4A-D illustrate out-data handler components 407a as adaptations and/or analogs of the out-data handler component 308 in FIG. 3. One or more out-data handler components 407a operate in an execution environment 401.

In FIG. 4A, a forwarding component 406a may provide data and a next protocol address to an out-data handler component 408a to send the data to a next node via a network interface identified by forwarding component 406a. The next node may be a destination node 506 or a path node 504 in a network path to transmit data from a source node 502 to the destination node 506. In FIG. 4A, an out-data handler 406a is illustrated operating in a network layer component 403a. The out-data handler component 402a may include the data in one or more network layer protocol data units including an address information field, as described above, addressed to the destination node 506 according to a network layer protocol of the network protocol component 403a.

The one or more network layer protocol data units may be provided to a link layer component 407a as data to include in one or more link layer protocol data units to transmit via a NIC 405a based on the network interface identified by the forwarding component 406a. In a node with one NIC operatively coupled to a physical data transmission medium or with multiple NICs operatively coupled to the shared data transmission medium, an out-data handler component 408a may send network layer data packets via the one NIC or any of the multiple NICs over the physical data transmission medium to deliver to the destination node 506 according to a network interface identified by the forwarding component 406a. Link layer protocol data units may be sent by the link layer component 407a according to a compatible link layer protocol and link layer address information. For example, Ethernet frames may be sent as link layer protocol data units via an Ethernet cable operatively coupled to a NIC 405a1 included in a suitable network path to transmit the data to the destination node 506.

FIG. 4B illustrates another exemplary execution environment 401b that may include and/or otherwise be provided by a path node 504 in FIGS. 5A-C. In FIG. 4B, the execution environment 401b includes a first line card 409b1 that includes a first NIC 405b1. The first line card 405b1 may be adapted to operatively couple the path node 504 to a previous network path with respect to data from a source node 502 to relay to a destination node 506. The execution environment 401b also includes a second line card 409b2 including a second NIC 405b2 to operatively couple the path node 504 to a next network path with respect to the data from the source node 502.

Data sent from a source node 502 and an identified destination node 506 may be received in a data unit of a network protocol by the first NIC 405b1 in the path node 504. The data may be detected by an in-data handler component 402b1 operatively coupled to first NIC 405b1. Address information may be detected in an address representation included in the data unit according to the network protocol. The in-data handler component 402b1 may send the address information to a routing component 404b via an internal communications medium 421b, such as a bus 116 in FIG. 1, to determine a next protocol address, in a scope-specific address space of the path node 504, that identifies a next node. The routing component 404b may include, be processed by, and/or otherwise interoperate with a general processing unit 419b and/or other hardware in processing the address information. A routing component 404b may be included, in some aspects, to also process protocol addresses that do not include an identifier of the next network interface component, or for routing IP addresses from global address spaces as currently specified by RFC 791 and RFC 3513.

The routing component 404b may determine the protocol address of the next node as describe above and/or in an analogous manner. The routing component 404b may provide some or all of the next protocol address to a forwarding component 406b. The forwarding component 406 may identify a second line card 409b2 including a second NIC 405b2, based on some or all of the next protocol address. The forwarding component 406b may interoperate with the GPU 419b to configure the internal data transmission medium 421b to deliver the data received in the data unit from the first line card 409b1 to the second line card 409b2 for final packaging in one or more data units of the network protocol by an out-data handler component 408b2. The out-data handler component 408b2 may interoperate with the a second NIC 405b to transmit the data via a data transmission medium to which the second NIC 405b2 is operatively coupled.

FIG. 4C illustrates still another exemplary execution environment 401c that may include and/or otherwise be provided by a path node 504 in FIGS. 5A-C. In FIG. 4C, the execution environment 401c includes a first line card 409c1 that includes a first NIC 405c1. The first line card 405c1 may be adapted to operatively couple the path node 504 to a previous network path with respect to data from a source node 502 for relaying to a destination node 506. The execution environment 401c also includes a second line card 409c2 including a second NIC 405c2 to operatively couple the path node 504 to a next network path with respect to the data from the source node 502.

In FIG. 4C, a routing component may be a distributed component. FIG. 4C illustrates that a routing component may be realized as routing agent components 404c included in line cards 409c in a path node 504. A forwarding component may also be distributed as illustrated in FIG. 4C by forwarding agent components 406c included in the line cards 409c. An FA component 406c1 may configure a switch interconnect unit (SIU) 421c to provide a communication channel from a first line card 409c1 to a second line card 409c2 and vice versa, as needed. Each line card 409c may include a switch interface (SI) component 423c to write data to a channel configured in the SIU component 421c and/or to read data from a channel.

A routing agent (RA) component, such as a first RA component 404c1, may identify a next protocol address based on address information detected by a first in-data handler (IDH) component 402c1. Based on some or all of the next protocol address, the first FA component 406c1 may identify a next line card 409c, such as the second line card 409c2, to transmit data received from a source node 502 to a next node identified by the next protocol address as described above with respect to FIG. 4A and FIG. 4B. The first FA 406c1 may setup a channel in the SIU component 421c to communicate the data via a first SI component 423c1 to a second SI component 423c2 of the second line card 409c2. The second SI component 423c2 may read the data communicated via the SIU component 421c and provide the data to a second out-data handler (ODH) component 408c2 in the second line card 409c2 to transmit to the next node. Data may be relayed from the destination node 506 to the source node 502 via a second IDH component 402c2 and a first ODH component 408c1 in an analogous manner.

The following aspects of the method illustrated in FIG. 2 have been described above and illustrated in the drawings identified above. The address information referred to FIG. 2 may include next protocol address information for identifying one or more of the current-next protocol address and a next-current protocol address that, in a next scope-specific address space specific to a next region including the next node, identifies the current node. Further, the address information may include previous protocol address information for identifying at least one of a previous-current protocol address that, in a previous scope-specific address space specific to a previous region that includes the previous node, identifies the current node and a current-previous protocol address that, in the current scope-specific address space, identifies the previous node.

Further, identifying the current-next protocol address may include identifying the current-next protocol address relative to a current location identifier that identifies a current location in a metric space including a network topology representing a node in the current region. The current-next protocol address identifies a next location in the metric space relative to the current location and the next location represents the next node. The current location may be defined as an origin in the metric space and the current scope-specific address space may be defined based on the metric space and the origin. The current-next protocol address may identify a next network path included in communicatively coupling the current node and the next node and may identify a sequence of locations in the metric space that respectively represent nodes in the next network path according to the network topology.

Additionally, the source-destination protocol address and/or the destination-source protocol address may include a plurality of hop identifiers identifying a sequence of hopes in a network path included in communicatively coupling the source node and the destination node. The address information may include the plurality of hop identifiers in an identifiable first order and in an identifiable second order. The source-destination protocol address may include the plurality of hop identifiers in the first order. The destination-source protocol address may include the plurality of hop identifiers in the second order. One or both of the first order and the second may be identified in the address information. One or both of the first order and the second order may be identified by sequence information represented separately from the plurality of hop identifiers.

A first hop including a first hop node and a second hop node, both in the network path, may be identified with respect to the previous node by a previous hop identifier in a previous scope-specific address space specific to a previous region that includes the previous node, identified with respect to the current node by a current hop identifier in the current scope-specific address space, and identified with respect to the next node by a next hop identifier in a next scope-specific address space specific to a next region that includes the next node.

The first hop identifier may be assigned from a first scope-specific address space specific to a first region that includes a network interface in the first hop node to identify the first hop in response to a negotiation between the nodes in the first hop.

The first hop node and the second hop node are communicatively coupled via a first network interface in the first hop node and via a second network interface in the second hop node, wherein the first hop identifier includes at least one of a first interface identifier identifying the first network interface and a second network interface identifying the second network interface to at least one of the first hop node and the second hop node.

A current-first path hop identifier that, in the current scope-specific address space, identifies the first hop and the current-first path identifier includes the first hop identifier, wherein the current-first path identifier identifies a network path that includes the current node as a path end node, the first hop node, and the second hop node. The first hop may be included in communicatively coupling the current node and one of the source node and the destination node. The current node may be either the first hop node or the second hop node. The previous-current protocol address may include the first hop identifier or the current-next protocol address may include the first hop identifier.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are that in operation perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more processors, or by a combination of both. The description herein of any sequence of actions is not intended to imply that the specific order described to perform that sequence must be followed.

Moreover, the methods described herein may be embodied in executable instructions stored in a non-transitory computer readable medium for use by or in connection with an instruction execution machine, system, apparatus, or device, such as a computer-based or processor-containing machine, system, apparatus, or device. As used here, a “non-transitory computer readable medium” may include one or more of any suitable media for storing the executable instructions of a computer program in one or more of an electronic, magnetic, optical, and electromagnetic form, such that the instruction execution machine, system, apparatus, or device may read (or fetch) the instructions from the non-transitory computer readable medium and execute the instructions for carrying out the described methods. A non-exhaustive list of conventional exemplary non-transitory computer readable media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), and a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for routing based on a scope-specific address space, the method comprising:
receiving data, via a network from a previous node by a current node via a previous network interface operatively coupling the current node to the network, in a data unit that is specified according to a network protocol and that includes address information;
detecting, based on the address information, a current-next protocol address that, in a current scope-specific address space specific to a current region including the current node, identifies a next node;
determining, based on the current-next protocol address, a next network interface operatively coupling the current node to the network; and
sending, via the next network interface, the data to the next node,
wherein performing at least one element identified as comprised in the method includes execution of an instruction by a processor.

2. The method of claim 1 wherein the data is received based on a previous-current protocol address that, in a previous scope-specific address space specific to a previous region that includes the previous node, identifies the current node.

3. The method of claim 1 wherein the next node is not included in the current region

4. The method of claim 1 wherein a next-current protocol address, in a next scope-specific address space specific to a next region that includes the next node, identifies the current node.

5. The method of claim 1 wherein detecting the current-next protocol address includes:
detecting, based on the address information, at least one of a previous-current protocol address that, in a previous scope-specific address space specific to a previous region that includes the previous node, identifies the current node and a previous-next protocol address that, in the previous scope-specific address space, identifies the next node; and
determining, the current-next protocol address based detecting at least one of the previous-current protocol address and the previous-next protocol address.

6. The method of claim 1 wherein the previous node, the current node, and the next node are included in a transmit network path to transmit the data sent by a source node to a destination node identified by the source node.

7. The method of claim 6 wherein the address information identifies at least one of a source-destination protocol address that, in a source scope-specific address space specific to a source region that includes the source node, identifies the destination node and a destination-source protocol address that, in a destination scope-specific address space specific to a destination region that includes the destination node, identifies the source node.

8. The method of claim 7 wherein the current-next protocol address is included in at least one of the source-destination protocol address and the destination-source protocol address.

9. The method of claim 7 wherein the address information includes next protocol address information for identifying at least one of the current-next protocol address and a next-current protocol address that, in a next scope-specific address space specific to a next region including the next node, identifies the current node and the address information includes previous protocol address information for identifying at least one of a previous-current protocol address that, in a previous scope-specific address space specific to a previous region that includes the previous node, identifies the current node and a current-previous protocol address that, in the current scope-specific address space, identifies the previous node.

10. The method of claim 9 further comprising:
detecting, in the data unit, address separating information specified according to the network protocol;
updating the address separating information for identifying, by at least one of the current node and the next node, at least one of the previous protocol address information and the next protocol address information in the address information.

11. The method of claim 7 wherein at least one of the source-destination protocol address and the destination-source protocol address includes a plurality of hop identifiers identifying a sequence of hops in the transmit network path included in communicatively coupling the source node and the destination node.

12. The method of claim 11 wherein the address information includes the plurality of hop identifiers in an identifiable first order and in an identifiable second order, wherein the source-destination protocol address is identified by the plurality of hop identifiers in the first order and the destination-source protocol address is identified by the plurality of hop identifiers in the second order.

13. The method of claim 1 wherein the network is represented in a network topology in a metric space and identifying the current-next protocol address includes identifying the current-next protocol address relative to a current location identifier that identifies a current location in the metric space representing a node in the current region, wherein the current-next protocol address identifies a next location in the metric space relative to the current location and the next location represents the next node.

14. The method of claim 13 wherein the current location is defined as an origin in the metric space and the current scope-specific address space is defined based on the metric space and the origin.

15. The method of claim 13 wherein the current-next protocol address identifies a next network path included in communicatively coupling the current node and the next node and identifies a sequence of locations in the metric space that respectively represent, in the network topology, nodes in the next network path.

16. The method of claim 13 wherein the current scope-specific address space respectively includes identifiers, that identify locations in a multi-dimensional metric space, that are defined based on a plurality of axes that intersect at a current-origin location in the metric space that represents the current region.

17. The method of claim 16 wherein a network interface of the current node at the current-origin location is identified based on an axis in the plurality of axes

18. The method of claim 17 wherein detecting the current-next protocol address includes detecting the current-next protocol address relative to a current-origin address that, in the current scope-specific address space, identifies the current-origin location in the metric space, wherein the current-next protocol address identifies a next location in the metric space relative to the current-origin location and the next location represents the next node.

19. A system for routing based on a scope-specific address space, the system comprising:
an in-data handler component that during operation of the system is included in receiving data, via a network from a previous node by a current node via a previous network interface operatively coupling the current node to the network, in a data unit that is specified according to a network protocol and that includes address information;
a routing component that during operation of the system is included in detecting, based on the address information, a current-next protocol address that, in a current scope-specific address space specific to a current region including the current node, identifies a next node;
a forwarding component that during operation of the system is included in determining, based on the current-next protocol address, a next network interface operatively coupling the current node to the network;
an out-data handler component that during operation of the system is included in sending, via the next network interface, the data to the next node; and
a processor, wherein at least one of the in-data handler component, the routing component, the forwarding component, and the out-data handler component includes an instruction that is executed by the processor during operation of the system.

20. A non-transitory computer-readable medium embodying a computer program, executable by a machine, for routing based on a scope-specific address space, the computer program comprising executable instructions for:
receiving data, via a network from a previous node by a current node via a previous network interface operatively coupling the current node to the network, in a data unit that is specified according to a network protocol and that includes address information;
detecting, based on the address information, a current-next protocol address that, in a current scope-specific address space specific to a current region including the current node, identifies a next node;
determining, based on the current-next protocol address, a next network interface operatively coupling the current node to the network; and
sending, via the next network interface, the data to the next node.
